(19) United States
(12) Patent Application Publication
(10) Pub. No.: US 2006/0209145 A1
(43) Pub. Date: Sep. 21, 2006

(54) Ink cartridge

(75) Inventors: Hiroaki Yazawa, Nagoya-shi (JP); Michifumi Ishigami, Nagoya-shi (JP); Sakiko Kobayashi, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/375,111

(22) Filed: Mar. 15, 2006

(30) Foreign Application Priority Data
Mar. 16, 2005 (JP) 2005-076138

(51) Int. Cl. B41J 2/175

(52) U.S. Cl. 347/86

(57) ABSTRACT

An ink cartridge is provided with a hollow cartridge body which can be attached to and detached from a cartridge attaching unit formed in an ink jet recording device, an ink storage chamber formed inside the cartridge, an ink supply port which can open in order to supply the ink to the ink jet recording device from the ink storage chamber and is sealed by a cap, and a plate-shaped handle which is rotatably provided on a front surface of the cartridge body and can take two postures of a standing posture where the handle stands up with respect to the front surface and a laid-down posture where the handle is laid down with respect to the same. The handle is configured so as to be exposed to outside when the cartridge body is attached to the cartridge attaching unit.

### CROSS-REFERENCE TO RELATED APPLICATIONS

This Nonprovisional application claims priority under 35 U.S.C. § 119(a) on Patent Application No. 2005-076138 filed in Japan on Mar. 16, 2005, the entire contents of which are hereby incorporated by reference.

### BACKGROUND OF THE INVENTION

1. Field of the Invention

The present invention relates to an ink cartridge that can be attached to and detached from a cartridge attaching unit of an ink jet recording device, in order to supply ink to the ink jet recording device.

2. Description of Related Art

Conventionally, as an ink jet recording device for feeding a recording medium inside a device body and recording an image, a device referred to as a multi function device (MFD) is known. FIG. 1 is a perspective view showing an outer appearance configuration of a conventional ink jet recording device. As shown in FIG. 1, an ink jet recording device 90 is a multi function device which is integrally provided with a printer unit 91 in its lower portion and a scanner unit 92 in its upper portion. The printer unit 91 is mainly connected to a computer (not shown) and records an image and/or a document on a recording paper in accordance with an image data and/or a document data transmitted from the computer. The scanner unit 92 reads the image data of various originals and converts into the image data and then outputs the image data after the conversion to the computer and the like.

As shown in FIG. 1, an opening 93 is formed on a front surface of the printer unit 91, and a paper feeding tray 94 and a paper discharging tray 95 are installed on two stages composed of upper and lower stages so as to be exposed to the opening 93. A conveying path having a shape of a laterally approximate U-shaped is formed inside the printer unit 91 extending from the paper feeding tray 94 to the paper discharging tray 95. In the midway of this conveying path, a recording unit is arranged for scanning an ink jet recording head and discharging the drop of the ink. The printer unit 91 of such configuration is used to record the image on the recording paper as described below. The recording paper placed on the paper feeding tray 94 is fed to the conveying path inside the printer unit 91 by conveying means such as a feeding roller (not shown) and the like. Then, in the midway of the conveying path, the recording unit is used to record the desired image on the recording paper. After that, the recording paper is discharged to the paper discharging tray 95.

The above mentioned ink jet recording head is configured such that the ink is supplied from a separately mounted ink cartridge through a piping, such as a tube and the like, and when the ink is exhausted by image recording, the ink cartridge can be exchanged. Such ink cartridge can be attached to and detached from a cartridge attaching unit (not shown) arranged inside the device body on the side of the paper discharging tray 95. Thus, for example, when a portion of the scanner unit 92 of the device body is configured such that it can be upwardly opened and closed, the ink cartridge can be exchanged by accessing the inside of the device body.

Also, the scanner unit 92 is configured as a so-called flat bed scanner, and a platen glass and an image scanner (both of them are not shown) are provided below a original cover 96 which is provided in openable/closable manner as the top board of the ink jet recording device 90. Since this image scanner is scanned in a predetermined direction, the image of the original placed on the platen glass is read.

Also, an operation panel 97 for carrying out various operations is provided on the front surface of the ink jet recording device 90. A slot section 98 to which various small memory cards serving as external recording media can be attached is provided below the operation panel 97.

FIG. 2 is a perspective view showing a cartridge attaching unit assembly 990 and an ink cartridge 100, which are received inside the device body of the conventional ink jet recording device 90. Such conventional ink jet recording device 90 can realize the color print through the inks composed of, for example, four colors. Thus, as shown in FIG. 2, four ink cartridges 100 for each of the four colors are configured so as to be able to be attached to and detached from the cartridge attaching unit 99 of the cartridge attaching unit assembly 990.

Although not shown in FIG. 2, the cartridge attaching unit 99 is connected through pipings, such as a tube and the like for each color to the ink jet recording head. Through each piping, each color ink is supplied from each ink cartridge 100 attached in the cartridge attaching unit 99 to the ink jet recording head.

Also, when the ink in the ink cartridge 100 is exhausted, a user detaches the ink cartridge 100 from the cartridge attaching unit 99 and attaches a new ink cartridge 100 and consequently can exchange the ink cartridge. In a case where the upper portion of the device body is configured to be opened as described in the conventional ink jet recording device 90, as shown in FIG. 2, the cartridge attaching unit 99 can be configured such that the ink cartridge 100 can be attached and detached upwardly and downwardly. In addition, in order to make the work for attaching/detaching the ink cartridge 100 easier, a handle 101 is provided protruding on the top surface of the ink cartridge 100. Thus, the user can grasp the handle 101 and attach and detach the ink cartridge 100.

The conventional ink jet recording device 90 as mentioned above is configured such that a recording surface of the recording paper is kept substantially horizontal in the paper feeding tray 94 or paper discharging tray 95 of the printer unit 91. Thus, as shown in FIG. 1, the device body of the conventional ink jet recording device 90 becomes, in many cases, a horizontally installing type, that is, a flat thin box-like shape in which a width and a depth (horizontal dimensions) are larger than a height (vertical dimension). However, the floor area for installing the horizontally installing type of the ink jet recording device must be inevitably large. Thus, in order to reduce the installation space, a vertically installing type of an ink jet recording device in which a height (vertical dimension) is larger than a width (first horizontal dimension) and/or a depth (second horizontal dimension) is proposed (for example, refer to Japanese Patent Application Laid-Open Patent No. 2003-127484).

Even in any case of the horizontally installing type such as the conventional ink jet recording device 90 and the vertically installing type such as the ink jet recording device proposed in Japanese Patent Application Laid-Open Patent No. 2003-127484, the further thinner and smaller structure of the device is desired for the purpose of the higher efficiency of office space and the like. Thus, the cartridge attaching unit 99 and the ink cartridge 100 are desired to be made as small as possible.

Also, the above mentioned conventional ink jet recording device 90 is configured such that, since the scanner unit 92 of the device body is upwardly opened, the ink cartridge 100 can be exchanged from the front of the device. Moreover, the components operated by the user, such as the operation panel 97, the slot section 98 and the like, are collectively arranged on the front of the device.

Also, by considering the possibility of leakage of the ink from the cartridge attaching unit 99, it is preferred to arrange the cartridge attaching unit 99 in the vicinity of the bottom surface of the device. With regard to this point, since the horizontally installing type is relatively wide in bottom area, the layout of the cartridge attaching unit 99 is easy.

On the other hand, although the vertically installing type of the ink jet recording device has the advantage that the installation area of the device is small, since the area of the side surface of the device is also small, it is difficult to arrange the cartridge attaching unit 99 on the bottom side of the device. Hence, it is also difficult to make the configuration where, by arranging the cartridge attaching unit 99 in the vicinity of the bottom surface of the device and being capable of opening the device body on the upper side thereof, the ink cartridge 100 can be consequently attached and detached upwardly and downwardly.

Moreover, in the vertically installing type of the ink jet recording device, it is also difficult to make the layout of all of the operation components, such as the operation panel 97 and the like, on the top surface side of the device. In particular, in the multi function device where the scanning function and the like are jointly mounted in the ink jet recording device, when the scanner unit and the like are provided on the front surface of the device, it is difficult to access the inside of the device body from the front side, and the space where the operation components can be placed is small. In this way, in the vertically installing type of the ink jet recording device, as the device itself becomes made smaller and thinner, the space where the layout of the ink cartridge, the operation components and the like can be configured becomes smaller.

For example, when the operation panel 97 is provided on the top surface of the device and when the slot section 98 and the cartridge attaching unit 99 are provided on the side surface of the device, respectively, the ink cartridge 100 is attached to and detached from the side surface of the device to the side direction. In this case, as shown in FIG. 2, it is apparent that the operability becomes poor as compared with the configuration where the ink cartridge 100 is attached and detached upwardly and downwardly. In particular, when the vertically installing type of the ink jet recording device is placed on the floor, the ink cartridge 100 is attached and detached from the side surface of the device to the side direction below the feet of the user. Thus, it is difficult for the user to visibly recognize the ink cartridge 100, and this fact becomes the main factor of the deterioration in the workability.

### BRIEF SUMMARY OF THE INVENTION

The present invention is devised in view of the above-mentioned problems. It is therefore an object of the present invention to provide an ink cartridge, for supplying ink to an ink jet recording device, in which the workability when being attached to and detached from the ink jet recording device is excellent and miniaturization can be realized by a simple configuration.

Also, another object of the present invention is to provide an ink cartridge in which the workability at a time of exchanging is improved in case of applying to a vertically installing type of an ink jet recording device.

An ink cartridge according to the present invention for an ink jet recording device is characterized by comprising: a hollow cartridge body which can be attached to and detached from a cartridge attaching unit formed in the ink jet recording device; an ink storage chamber which is formed inside the hollow cartridge body, and stores an ink; an ink supply port which can open in order to supply the ink from the ink storage chamber to an outside of the cartridge body, and is sealed by an ink sealing member; and a plate-shaped handle which is rotatably provided on a front surface of the cartridge body, and can take two postures of a standing posture to be stood up with respect to the front surface of the cartridge body, and a laid-down posture to be laid down with respect to the same; wherein the handle is exposed to outside when the cartridge body is attached to the cartridge attaching unit.

In the ink cartridge according to the present invention as mentioned above, in the state that of being attached to the cartridge attaching unit, since the plate-shaped handle is positioned so as to be integrated with the front surface of the cartridge body, because it is laid down with respect to the front surface of the cartridge body. Thus, the protruding width from the cartridge body becomes small. Inversely, when the ink cartridge is pulled out from the cartridge attaching unit, the user changes the posture of the handle from the laid-down posture to the standing posture. Then, the user can grip the handle and pull out the ink cartridge.

The above and further objects and features of the invention will more fully be apparent from the following detailed description with accompanying drawings.

### BRIEF DESCRIPTION OF THE SEVERAL VIEWS OF THE DRAWINGS

FIG. 1 is a perspective view showing an outer appearance configuration of a conventional ink jet recording device;

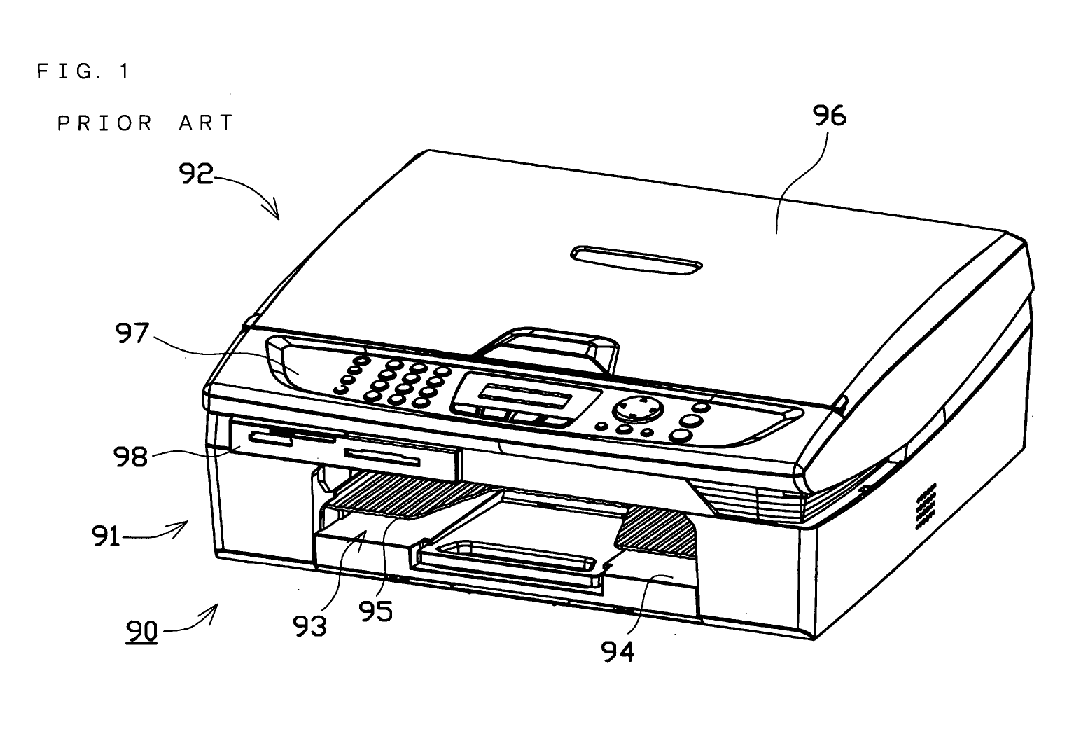

FIG. 2 is a perspective view showing a conventional cartridge attaching unit and ink cartridge;

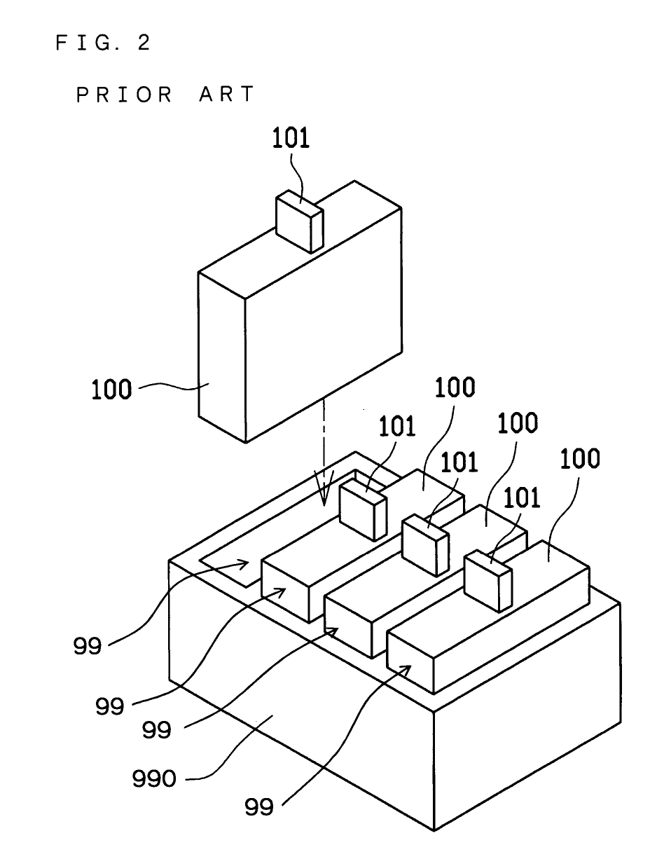

FIG. 3 is a perspective view showing an outer appearance configuration of an ink cartridge according to a first embodiment of the present invention;

FIG. 4 is a sectional view taken on the line A-A line of FIG. 3 in order to indicate the inner configuration of the ink cartridge;

FIG. 5 is a perspective view showing an outer appearance configuration of an ink jet recording device;

FIG. 6 is a side view showing the outer appearance configuration of the ink jet recording device;

FIG. 7 is a longitudinally sectional view showing an inner configuration of the ink jet recording device;

FIG. 8 is a block diagram showing a configuration of a controlling unit composed of electric parts;

FIG. 9 is a diagrammatic view explaining an ink supply route to an ink jet recording head from a cartridge attaching unit;

FIG. 10 is a longitudinally sectional view showing a configuration of the cartridge attaching unit;

FIG. 11 is a longitudinal sectional view showing a state where the ink cartridge is attached to the cartridge attaching unit;

FIG. 12 is a longitudinal sectional view showing a state that a handle of the ink cartridge is set at a standing posture;

FIG. 13 is a longitudinal sectional view showing a state that the ink cartridge is pulled from the cartridge attaching unit;

FIG. 14 is a longitudinal sectional view showing an inner configuration of an ink cartridge according to a second embodiment of the present invention;

FIG. 15 is a longitudinal sectional view showing a state that the ink cartridge is pulled from the cartridge attaching unit;

FIG. 16 is a longitudinal sectional view showing an inner configuration of an ink cartridge according to a third embodiment of the present invention; and

FIG. 17 is a longitudinal sectional view showing a state that the ink cartridge is pulled from the cartridge attaching unit.

### DETAILED DESCRIPTION OF THE PRESENT INVENTION

The embodiments of the present invention will be described below by properly referring to the drawings.

### First Embodiment

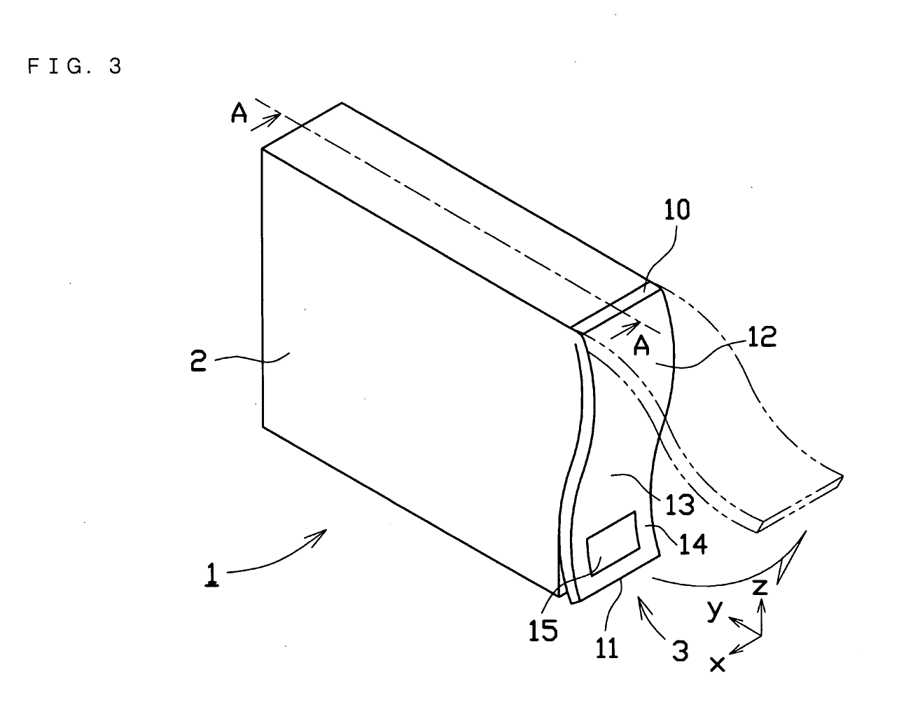

FIG. 3 is a perspective view showing the outer appearance configuration of an ink cartridge 1 according to a first embodiment of the present invention. As shown in FIG. 3, the ink cartridge 1 is provided with a rectangular parallelepiped shape cartridge body 2 and a handle 3 rotatably provided on the front surface of the cartridge body 2.

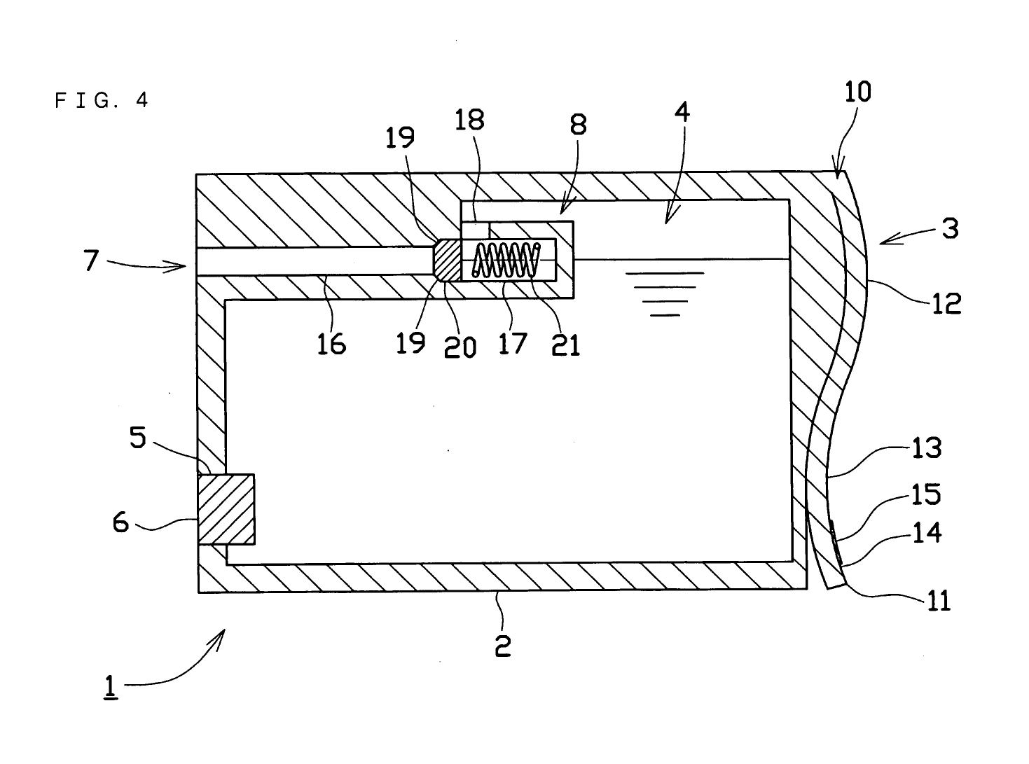

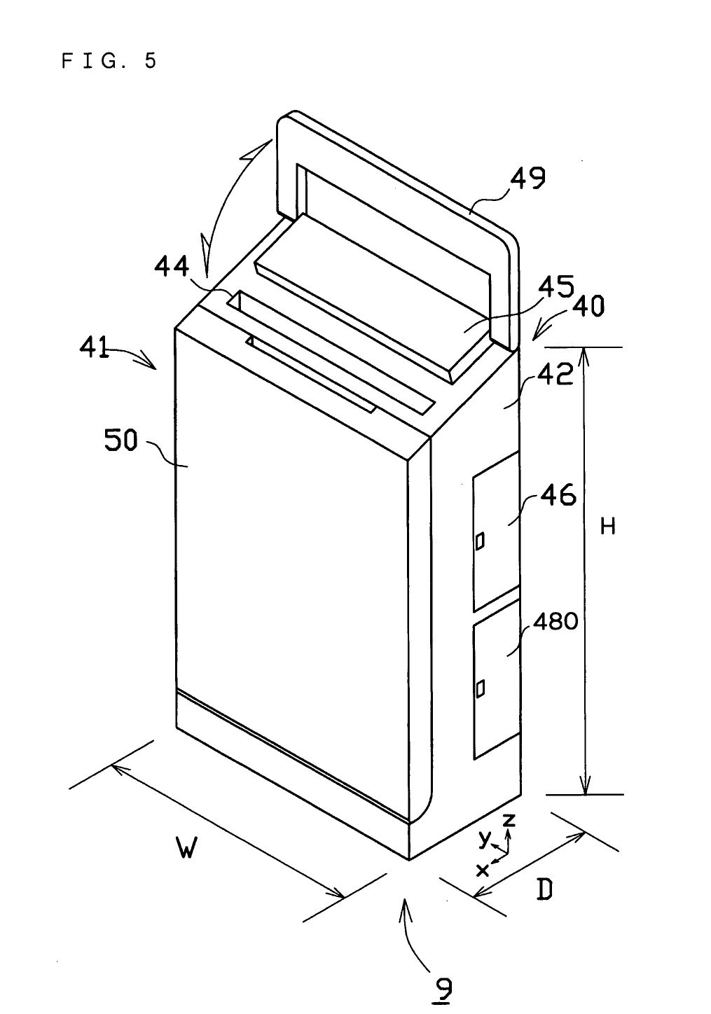

The cartridge body 2 is the hollow body constituting the outer shape of the ink cartridge 1, and an ink storage chamber 4 (refer to FIG. 4) for storing a predetermined amount of ink is formed therein. The cartridge body 2 is a thin rectangular parallelepiped body where its width (an x-direction in FIG. 3) is formed smaller than a height (a z-direction in FIG. 3), corresponding to an ink jet recording device 9 (refer to FIG. 5) of a vertically installing type, and it is attached to the ink jet recording device 9 so that the height direction (the z-direction in FIG. 3) as the longitudinal direction on the front surface becomes a vertical direction. The detailed operation for attaching to and detaching from the ink jet recording device 9 of the vertically installing type will be described later. The ink cartridge 1 is configured so as to be attached to or detached from the side surface of the ink jet recording device so that it is inserted or pulled out in the side direction. The y-direction in FIG. 3 is the inserting/pulling direction of the ink cartridge 1 and also the depth direction of the cartridge body 2. The cartridge body 2 is embodied, for example, as the molded product of synthetic resin, for example, PP (Polypropylene) and the like.

The above mentioned handle 3 is provided on the surface of the cartridge body 2 to be rotatable toward the front side of the cartridge body 2, namely, it is rotatable to be exposed onto the outer surface of the ink jet recording device 9 when the ink cartridge 1 is attached to the side surface of the ink jet recording device 9. This handle 3 is formed integrally with the cartridge body 2 under a state where the upper end portion on the front surface of the cartridge body 2 is made as a hinge portion 10. Thus, the handle 3 can take the two postures, that is, a standing posture (indicated by an alternate long and two short dashes line) in which the handle 3 stands up with respect to the front surface of the cartridge body 2 and a laid-down posture (indicated by a solid line) in which the handle 3 is laid down with respect to the same, as shown in FIG. 3.

Instead of the hinge portion 10, a shaft parallel to the width direction (x-direction) of the cartridge body 2 may be provided protruding on the upper end portion on the front surface of the cartridge body 2, and the upper end portion of the handle 3 may be rotatably assembled in the shaft. However, the hinge portion 10 is formed on the cartridge body 2, and the cartridge body 2 and the handle 3 are integrally formed in the state connected through the hinge portion 10 so that the handle 3 can be simply embodied at a low cost. When the handle 3 is formed separately from the cartridge body 2 with the material of a color substantially equal to an ink color stored in the ink cartridge 1 and is assembled through the shaft to the cartridge body 2 as described above, the stored ink color can be identified by the color of the handle 3.

Also, the handle 3 is a corrugated plate having a curvature. In the laid-down posture indicated by the solid line in FIG. 3, namely, in the state where the handle 3 is laid down with respect to the front surface of the cartridge body 2, a rotating tip portion 11 is curved so as to rise and separate with respect to the front surface of the cartridge body 2 (to the side direction of the device body of the ink jet recording device 9). Thus, as shown in FIG. 3 and FIG. 4, since a gap is generated between the cartridge body 2 and the handle 3 in the rotating tip portion 11, the user is easy to grip the rotating tip portion 11. Moreover, on the portion of a rotating axis side (the hinge portion 10 side) out of the center portion in the vertical direction of the handle 3, a top portion 12 rising from the front surface of the cartridge body 2 (to the side direction of the device body of the ink jet recording device 9) is formed. Also, on the portion of the rotating tip portion 11 side out of the center portion in the vertical direction of the handle 3, a valley portion 13 recessed toward the front surface of the cartridge body 2 is formed. Since the foregoing rotating tip portion 11, top portion 12 and valley portion 13 are formed continuously as the gentle curvature, the handle 3 has the corrugated shape that rises and is recessed along the vertical direction.

As mentioned above, since the valley portion 13 whose surface is recessed is formed from the center portion of the handle 3 towards the side of the rotating tip portion 11, the surface of the handle 3 rises from the valley portion 13 towards the rotating tip portion 11. Hence, an upward slant surface 14 where the surface of the handle 3 faces in the obliquely upward direction is formed from the valley portion 13 to the rotating tip portion 11. A label 15 is stuck on this upward slant surface 14, and the ink color stored in the ink cartridge 1 is represented in this label 15.

The representation of the ink color may be the representation such as a character and/or symbol, mark and the like, which can be visibly recognized by the user. Thus, for example, when the ink cartridge according to the present invention is applied to an ink jet recording device which uses the four color inks of cyan, magenta, yellow and black, characters such as “SYAN”, “MAGENTA”, “YELLOW” AND “BLACK”, or head characters such as “C”, “M”, “Y” and “Bk” may be represented. Moreover, when the labels 15 to represent the cyan, the magenta, the yellow and the black are assumed to be blue, red, yellow and black to represent the respective ink colors, this can be also identified as color sense. The representing method of the ink color is not especially limited. For example, it is naturally possible to employ the other known technique, such as the technique for directly printing the character on the surface of the handle 3 instead of the label 15.

FIG. 4 is a sectional view taken on the line A-A of FIG. 3 in order to show the inner configuration of the ink cartridge 1.

As shown in FIG. 4, the ink storage chambers 4 for storing the inks are formed inside the cartridge body 2. The ink storage chambers 4 may be configured by the cartridge body 2, if they are the sealed spaces formed inside the cartridge body 2, as shown in FIG. 4, or, for example, they may be constituted by ink packs made of synthetic resin film of multi-layer structure. In the ink storage chambers 4, the ink to be supplied to the ink jet recording device 9 are stored. As mentioned above, when the ink cartridges according to the present invention are applied to the ink jet recording device that uses the four-color inks composed of cyan, magenta, yellow and black, each of the ink storage chambers 4 of the four ink cartridges 1 stores each of the color inks.

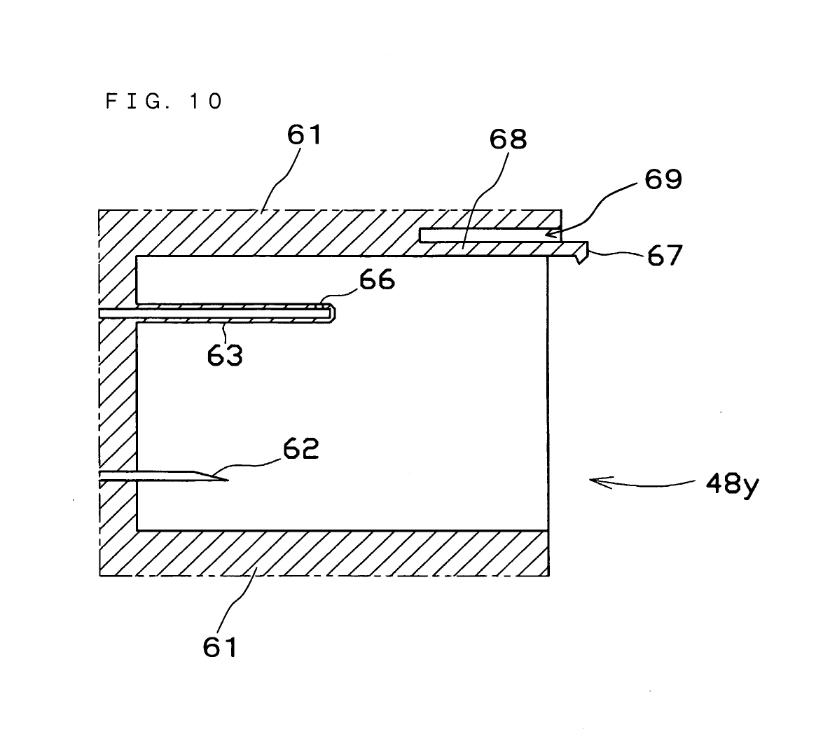

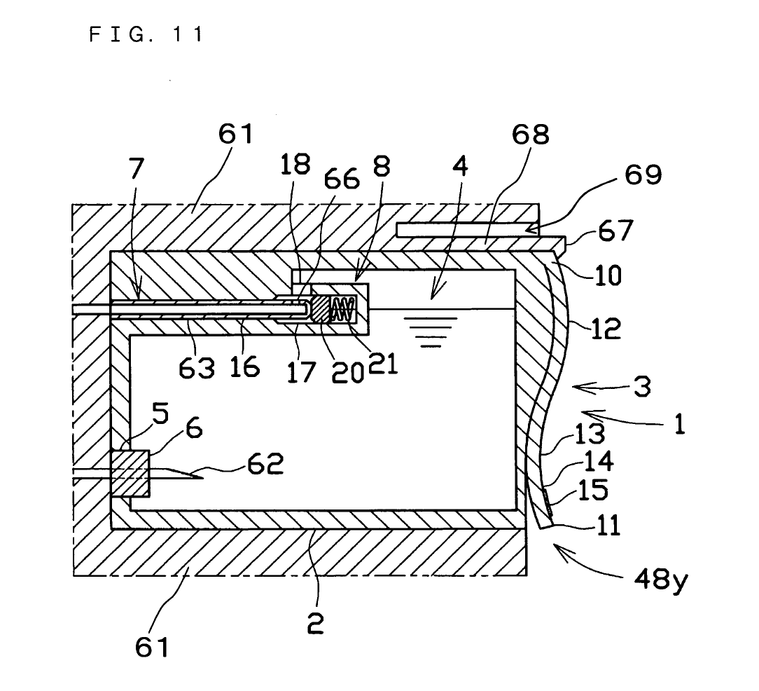

Also, an ink supply port 5 communicating to the ink storage chamber 4 from the rear side of the cartridge body 2 is opened on the vicinity of the lower end portion of the rear surface of the cartridge body 2. This ink supply port 5 is sealed by a cap 6 (sealing member). The cap 6 is the cylindrical elastic body having the size that enables the ink supply port 5 to be sealed. For example, silicon rubber and the like can be used as the cap 6. As described later, the cap 6 made of such elastic body is opened since it is pierced by a hollow ink needle 62 (for example, refer to FIG. 10 and FIG. 11 and the like) when the cartridge body 2 is attached to a cartridge attaching unit 48. Thus, the ink in the ink storage chamber 4 flows out from the cartridge body 2 through the ink needle 62. On the other hand, after the ink needle 62 is pulled out from the cap 6, the pierced trace of the ink needle 62 is sealed by the elasticity of the cap 6.

Consequently, when the ink cartridge 1 is attached to the cartridge attaching unit 48, the ink can be supplied from the ink storage chamber 4. Inversely, when the ink cartridge 1 is detached from the cartridge attaching unit 48, the ink cannot be supplied from the ink storage chamber 4. The sealing member according to the present invention is not necessarily limited to the elastic material such as the cap 6. It is naturally possible to use another sealing means that can be opened when the ink cartridge 1 is attached to the cartridge attaching unit 48, such as, for example, a check valve and the like.

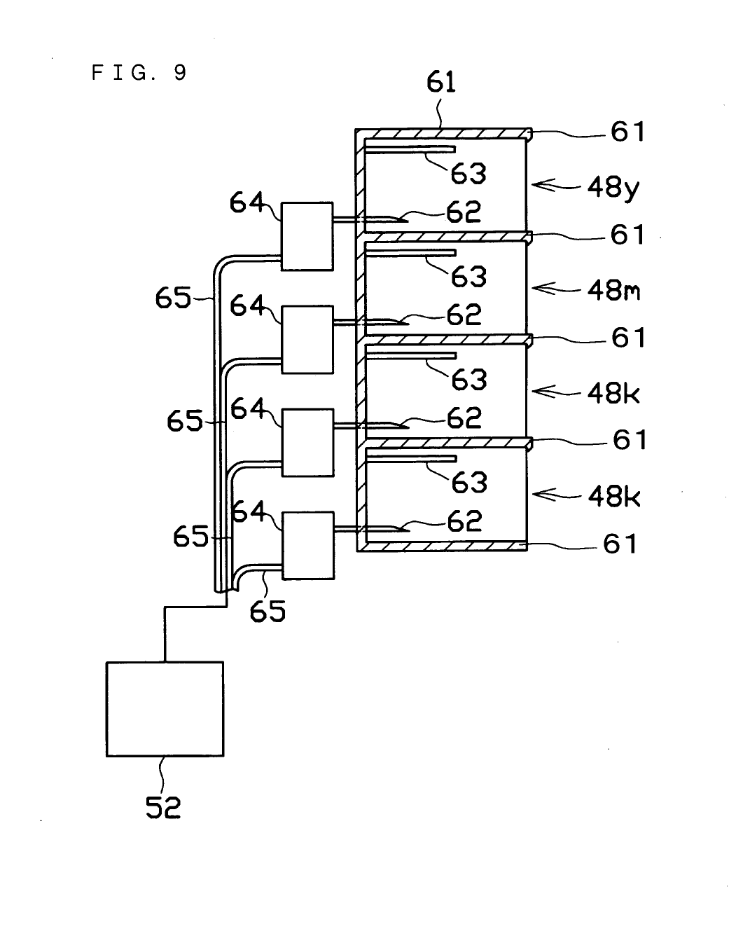

Also, a guiding unit 7 is provided in the vicinity of the upper end portion on the rear side of the cartridge body 2. The guiding unit 7 is the circular hole opened from the rear surface of the cartridge body 2 towards the front surface of the same. Since a bar-shaped guiding member 63 (refer to FIG. 9) provided protruding in the cartridge attaching unit 48 of the ink jet recording device 9 is inserted into this guiding unit 7, the inserting/pulling direction of the ink cartridge 1 that is attached to and detached from the cartridge attaching unit 48 is guided. The guiding unit 7 is horizontally formed from the vicinity of the upper end portion on the rear surface of the cartridge body 2 towards the front surface up to the vicinity of the midway in the depth direction of the cartridge body 2. Moreover, the hinge portion 10 serving as the rotating axis of the handle 3 is located near the position where a production in an extending direction of the guiding unit 7 reaches the front surface of the cartridge body 2, namely, near the upper end portion of the front surface of the cartridge body 2. The first embodiment employs the configuration where the guiding unit 7 is made as the hole (circular hole). However, instead of this, for example, it is possible to embody the configuration where the side surface of the cartridge body 2 is depressed to form a groove, and this is made as the guiding unit, and a protruding ridge formed inside the cartridge attaching unit 48 is engaged with the groove. Moreover, the guiding unit can be made as the other concave and convex shape.

An atmosphere communicating path 8 to open the ink storage chamber 4 to atmosphere is provided in the portion on the depth side of the guiding unit 7 (the portion near the front surface of the cartridge body 2). As shown in FIG. 4, the circular hole constituting the guiding unit 7 is formed as a small diameter portion 16 having a relatively small diameter, on the rear surface of the cartridge body 2 and formed as a large diameter portion 17 having a relatively large diameter, on the front surface of the cartridge body 2. A ventilation port 18 communicating to the ink storage chamber 4 is opened on the top surface of the large diameter portion 17. Thus, the ink storage chamber 4 is configured so as to communicate from this ventilation port 18 through the space inside the circular hole of the guiding unit 7 to outside the cartridge body 2.

A tapered plane 19 whose diameter is increased from the small diameter portion 16 to the large diameter portion 17 is formed on the side of the small diameter portion 16 out of the ventilation port 18 of the guiding unit 7. A sealing member 20 is inserted into the circular hole of the guiding unit 7 so that one end is brought into contact with the tapered plane 19. The sealing member 20 is the cylindrical member whose diameter is substantially equal to that of the large diameter portion 17 and slidably provided inside the large diameter portion 17. The other end of the sealing member 20 is elastically pushed against the rear surface of the cartridge body 2 by a spring 21 inserted into the portion deeper than the sealing member 20 of the large diameter portion 17. Thus, the sealing member 20 is brought into compressive contact with the sealing member 20 inside the guiding unit 7. In this state, the portion deeper than the small diameter portion 16 of the guiding unit 7 is sealed. Consequently, since the path from the ventilation port 18 to the small diameter portion 16 is blocked, the ink storage chamber 4 is blocked against the atmosphere outside the cartridge body 2. The position of the sealing member 20 in this state is referred to as a block position. On the other hand, when the sealing member 20 is pushed to the deeper side of the large diameter portion 17, in opposition to the elastically pushing force of the spring 21, the sealing member 20 is moved to the portion deeper than the ventilation port 18 inside the guiding unit 7. Thus, since the path from the ventilation port 18 to the small diameter portion 16 is opened, the ink storage chamber 4 is opened to the atmosphere outside the cartridge body 2. The position of the sealing member 20 in this state is referred to as the open position.

The ink jet recording device 9 to which the ink cartridge 1 according to the present invention is attached as mentioned above will be described below.

FIG. 5 is a perspective view showing an outer appearance configuration of the ink jet recording device 9 to which the ink cartridge 1 according to the present invention is attached. The ink jet recording device 9 is the multi function device (MFD) that is integrally provided with a printer unit 40 on the rear surface side and a scanner unit 41 on the front surface side, so that the printer function and the scanner function are jointly installed. By the way, since the scanner function is an optional function, it may be omitted. Also, when the ink jet recording device 9 is further provided with a communicating unit, it may have a facsimile function and the like.

The ink jet recording device 9 is mainly connected to a computer (not shown). In accordance with the image data and/or the document data transmitted from the computer, the printer unit 40 records an image and/or a document on a recording paper. The scanner unit 41 reads the image data of various originals and converts into the image data and then outputs the image data after the conversion to the computer and the like. However, even the single ink jet recording device 9, when an external device such as a digital camera or the like is connected, can record the image data outputted from the digital camera or the like on the recording paper, and when various recording media such as a small memory card and the like are attached, can record the image data recorded in the attached media and the like, on the recording paper.

As shown in FIG. 5, a width W and a height H of the printer body 42 (device body) of the ink jet recording device 9 are configured so as to be slightly larger than the A4 size, in order to held and feed the recording paper of the maximum width on which the image can be recorded, for example, the recording paper of an A4 size. On the contrary, a depth D of the printer body 42 (device body) is configured so as to be smaller than both of the width W and the height H. Thus, the entire shape of the printer body 42 is the flat and rectangular parallelepiped shape. The ink jet recording device 9 is the vertically installing type which installs the printer body 42 so as to make the height, namely, the longitudinal direction of the side surface of the printer body 42 vertical (the z-direction of FIG. 5). In this way, when the ink jet recording device 9 is the vertically installing type, the small and thin sizing of the ink jet recording device 9 can be realized, which reduces the required area for installation and also improves the portability.

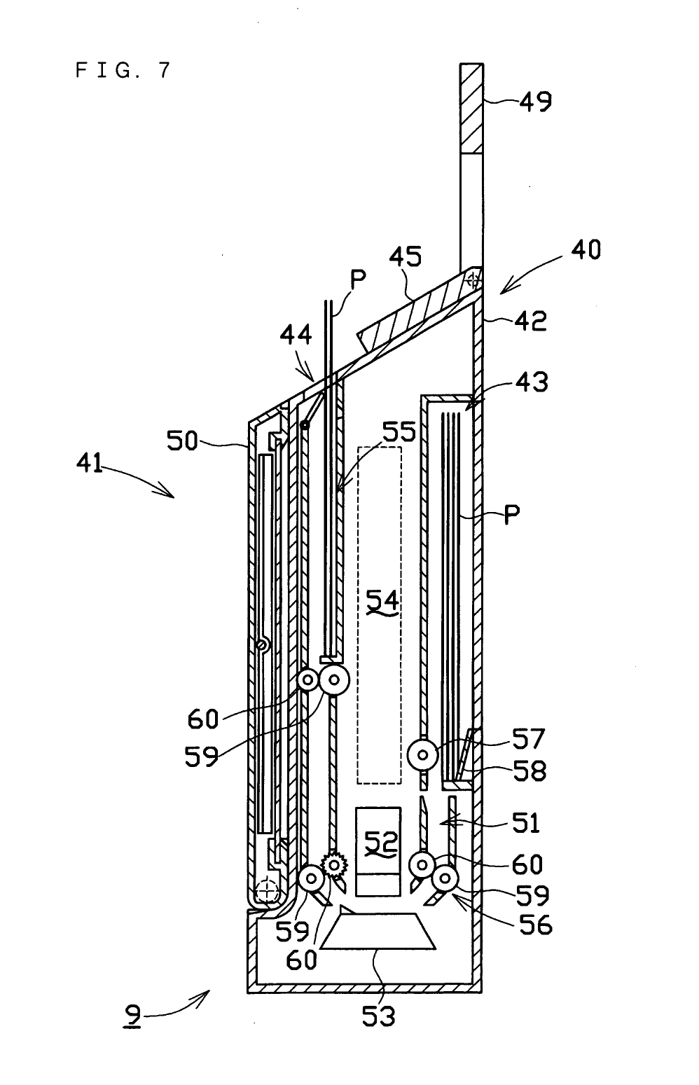

A recording paper receiving unit 43 (refer to FIG. 7) is formed in the portion on the rear surface side inside the printer body 42. Also, a paper discharging port 44 is upwardly opened on the top surface of the printer body 42. Although the detail thereof will be described later, a conveying path 51 is formed from the recording paper receiving unit 43 to the paper discharging port 44 (refer to FIG. 7). An ink jet recording head 52 (refer to FIG. 7) records the image on the recording paper conveyed by a conveying mechanism 56 (refer to FIG. 7) along this conveying path 51. The recording paper on which the image is already recorded is discharged upwardly from the paper discharging port 44.

An operation panel 45 for the user to operate the ink jet recording device 9 is arranged on the rear surface side out of the paper discharging port 44 on the top surface of the printer body 42. The operation panel 45 is composed of various operation buttons and a liquid crystal display and the like to carry out the various settings and the like of the ink jet recording device 9. The ink jet recording device 9 operates in accordance with not only the operational instruction from the operation panel 45 but also the instruction transmitted through a printer driver from the connected computer or scanner driver. Also, the top surface of the printer body 42 is inclined downwardly towards the front surface side. Thus, the operation panel 45 is also inclined corresponding to the inclination of the top surface of the printer body 42. Consequently, the user can operate the various operation buttons and the display of the operation panel 45 while easily visibly recognizing them from both directions of the front surface side and the top surface side of the ink jet recording device 9. Hence, even when the ink jet recording device 9 is installed on any of a desk and a floor, there is an advantage that the visible recognizing property and the workability are excellent.

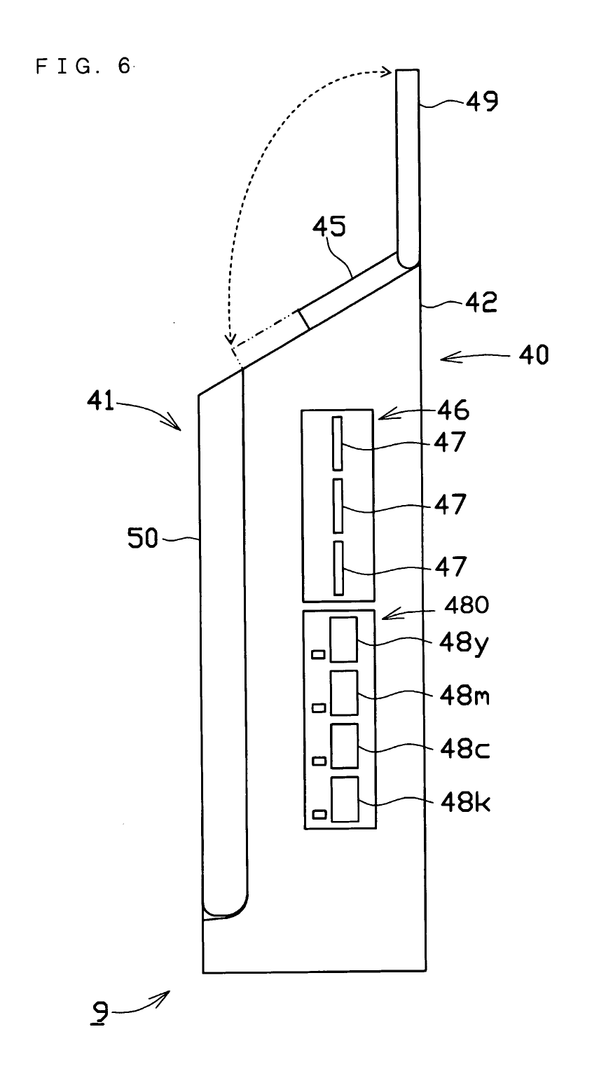

Also, a media attaching portion 46 to which various small memory cards as the external recording media can be attached is provided on the side surface of the printer body 42. When the media attaching portion 46 is not used, as shown in FIG. 5, the opening is closed by an openable/closable door. Thus, the invasion of foreign materials such as dusts is prevented. As shown in FIG. 6, when the door of the media attaching portion 46 is opened, each slot 47 is exposed to the side surface of the printer body 42. Thus, each small memory card can be removed from and inserted into the side direction of the printer body 42 for each slot 47. In FIG. 6, the door for closing the media attaching portion 46 and the cartridge attaching section 480 is omitted for the convenience of the explanation.

Each slot 47 of the media attaching portion 46 connects the small memory cards based on various standards referred to as, for example, an SD memory card or compact flash (registered trademarks), a smart media (a registered trademark), a memory stick (a registered trademark) and the like, to the ink jet recording device 9 so that data can be transmitted and received. The respective slots 47 have the shapes corresponding to the small memory cards based on three kinds of standards, respectively. Those three kinds of the slots 47 are opened on the side surface of the printer body 42 and vertically arranged in lines. For example, a still image data photographed by a digital camera and a motion image data photographed by a digital video camera are recorded in the small memory card. Thus, when the small memory card is attached to the slot 47 according to the standard, the ink jet recording device 9 can read the image data recorded in the small memory card attached to the slot 47 and record any image on the recording paper by using the printer unit 40. The number of the slots 47 of the media attaching portion 46 can be freely increased and decreased.

Moreover, the cartridge attaching section 480 to which the ink cartridges for the respective color inks of cyan (C), magenta (M), yellow (Y) and black (K) are attached is provided on the side surface on which the media attaching portion 46 of the printer body 42 is provided. In the cartridge attaching section 480, as shown in FIG. 5, similarly to the media attaching portion 46 as mentioned above, when the ink cartridge is not exchanged, the opening is closed by the openable/closable door, and the invasion of the foreign materials such as the dusts and the like is protected. When the door (not shown) of the cartridge attaching section 480 is opened, as shown in FIG. 6, the openings of four cartridge attaching units 48 (48y, 48m, 48c and 48k) are exposed for the ink cartridges 1 for the respective colors. The respective ink cartridges 1 are removed from and inserted into those respective cartridge attaching units 48y, 48m, 48c and 48k, from the side direction of the printer body 42, so that the ink cartridge 1 is exchanged. The ink cartridge 1 is attached to each of the cartridge attaching units 48y, 48m, 48c and 48k, as shown in FIG. 3, under the state where the longitudinal direction of the front surface of the cartridge body 2 is vertical.

The cartridge attaching section 480 is arranged on the lower side than the media attaching portion 46 on the same side surface of the printer body 42. This provides the following advantages. The respective ink cartridges 1 for storing the respective color inks are attached to the cartridge attaching units 48y, 48m, 48c and 48k for the respective colors constituting the cartridge attaching section 480. However, when the ink cartridge 1 is attached or detached, there is a fear of slight ink leakage. With regard to such ink leakage, typically, ink absorbers are suitably provided in the cartridge attaching units 48y, 48m, 48c and 48k so that the leaked ink does not invade the inside of the printer body 42 and the like. However, because of the working miss when the ink cartridge 1 is exchanged and the like, the possibility where a large quantity of ink leakage occurs to a degree that it cannot be absorbed by the ink absorber is not zero. However, even if the accidental ink leakage occurs in any cartridge attaching unit 48, the media attaching portion 46 provided on the upper side than the cartridge attaching section 480 and the small memory card attached to the media attaching portion 46 are never contaminated by the ink leaked from any cartridge attaching unit 48.

Moreover, the respective cartridge attaching units 48y, 48m, 48c and 48k are vertically arranged in the lines while the cartridge attaching unit 48y in which the ink cartridge 1 (refer to FIG. 3) storing the yellow ink that is the lightest color in the respective ink colors of cyan, magenta, yellow and black is located on the highest side. Then, in the order starting from the light ink color, namely, the cartridge attaching units 48y, 48m, 48c and 48k in which the ink cartridges storing the inks for magenta, cyan and black, respectively, are attached are arranged in this order from the upper side to the lower side in a line.

In this way, in the vertically installing type of the ink jet recording device 9, the ink cartridge 1 is attached to the cartridge attaching unit 48, under the state where the longitudinal direction of the front surface of the cartridge body 2 is vertical. Thus, since the cartridge attaching unit 48 can be made thinner, the ink jet recording device 9 can be made thinner as a result. Also, the cartridge attaching section 480 is provided on the side surface of the printer body 42, and the respective cartridge attaching units 48y, 48m, 48c and 48k corresponding to the respective color ink cartridges of CMYK are vertically arranged in the lines. Thus, the workability when the ink cartridge is exchanged is improved, and the thickness of the printer body 42 is made thinner, which realizes the small and thinner structure of the ink jet recording device 9. Also, it is possible to reserve the space where the other operation members, such as the scanner unit 41, the operation panel 45 and the like, are provided on the top surface and front surface of the printer body 42.

Also, the cartridge attaching units 48y, 48m, 48c and 48k for the respective colors are arranged from the upper side to the lower side in the order starting from the light ink color. Thus, for example, when the ink leakage occurs as mentioned above, even if the lightest yellow ink is mixed into the magenta, cyan and black inks which are denser than the yellow ink and supplied from the ink cartridges 1 on the side below it, the influence on the recorded image can be reduced.

Also, the respective cartridge attaching units 48y, 48m, 48c and 48k are all provided on the same side surface of the printer body 42. Moreover, those cartridge attaching units 48y, 48m, 48c and 48k and the media attaching portion 46 are provided on the same side surface of the printer body 42. Thus, the exchanging works for all of the ink cartridges and the attaching/detaching works of the media can be carried out on one side surface of the ink jet recording device 9. Accordingly, the workability of the ink jet recording device 9 is improved. By the way, in this embodiment, the media attaching portion 46 and the cartridge attaching section 480 are provided on the left side surface of the ink jet recording device 9, in other words, on the right side surface when they are viewed by the user. This is because the number of the right-handed users is relatively greater than the number of the left-handed users. Hence, even if all of them are provided on the right side surface of the ink jet recording device 9, the similar effect is naturally obtained except the problem of the user's dominant hand.

Also, as shown in FIG. 5 and FIG. 6, in the upper portion of the printer body 42, a handle 49 formed in U-shaped not to interfere with the operation panel 45 is swingably provided so as to be able to have any of a laid-down posture in which the handle 3 is laid down with respect to the top surface of the printer body 42 and a standing posture in which the handle 3 stands up with respect to the same. The handle 49 is set at the standing posture in which the handle 3 stands up with respect to the top surface of the printer body 42, as indicated by the solid lines in FIG. 5 and FIG. 6, when the ink jet recording device 9 is used. In this case, the handle 49 serves as the hand to carry the device and also opens the paper discharging port 44. On the other hand, when the ink jet recording device 9 is not used, as indicated by an alternate long and two short dashes line in FIG. 6, the handle 49 is set at the laid-down posture in which the handle 3 is laid down with respect to the top surface of the printer body 42 and closes the paper discharging port 44. In this case, the handle 49 protects the foreign materials such as dusts and the like from invading into the device.

The scanner unit 41 is configured as a so-called flat bed scanner. As shown in FIG. 5, a width and a height of the scanner body 50 of the scanner unit 41 are configured so as to be slightly larger than those of the A4 size, corresponding to the maximum original from which the image can be read, for example, the original of the A4 size. On the contrary, the depth is smaller than both of the width and the height. Thus, the entire shape of the scanner body 50 is a flat rectangular parallelepiped shape. A read surface of the scanner unit 41 is formed as one surface of the scanner body 50. Although this is not shown, this surface is opposite to the front surface of the printer body 42. Also, the lower end portion of the scanner body 50 is swingably supported at the lower end portion of the printer body 42. Hence, the upper end portion side of the scanner body 50 can be opened from and closed to the front surface of the ink jet recording device 9.

When the scanner unit 41 is not used, as shown in FIG. 5, the outer shape of the entire device becomes the flat rectangular parallelepiped shape under the state where the height direction of the printer body 42 and the height direction of the scanner body 50 become the same direction. Thus, in this case, in such a way that the height direction of the entire device is vertical, for example, the ink jet recording device 9 becomes the vertically installing type as a whole which is installed on a desk or the like. Also, when the scanner unit 41 is used, the user grips the upper end portion, and inclines the scanner body 50 to the front surface side (the x-direction in FIG. 5) with the lower end portion as the rotation center. Then, in this state, the user positions a desirable original on a platen glass constituting the read surface, and then makes an image sensor read the image of the original. By the way, since the scanner unit 41 is the optional function in the ink jet recording device 9, it is not always required to be included.

FIG. 7 is a longitudinal sectional view showing the inner configuration of the ink jet recording device 9. As shown in FIG. 7, the printer unit 40 is provided with the recording paper receiving unit 43, the conveying path 51, the ink jet recording head 52, a platen 53, electronic parts 54, a paper discharging stack 55, the conveying mechanism 56 and the like, which are built in the printer body 42.

The recording paper receiving unit 43 is provided in order to store the recording paper serving as the recording medium and also feed the recording paper to the conveying path 51. Then, the recording paper receiving unit 43 can receive the recording papers of various sizes, for example, A4 size, and B5 size, postcard size and the like which are smaller than the A4 size. A plurality of recording papers P received in the recording paper receiving unit 43 are kept in the standing posture where the recording surface faces to the inner side of the device.

As shown in FIG. 7, the lower end portion of the recording paper receiving unit 43 is communicated to the conveying path 51. Also, a paper feeding roller 57, which separates the recording papers P held by the recording paper receiving unit 43, one by one, and supplies them to the conveying path 51, is provided immediately under the lower end portion of the recording paper receiving unit 43. A guide 58 for holding the lower end portion of the recording paper P at the position from which the paper is fed is provided at the position opposite to the paper feeding roller 57. The guide 58 is pushed against the paper feeding roller 57 side by a spring and the like (not shown) and configured so as to bring the lower end portion of the recording paper P at the standing posture into compressive contact with the paper feeding roller 57. Thus, when the paper feeding roller 57 is rotated in the state that the lower end portion of the recording paper P is in the compressive contact, the friction force with the paper feeding roller 57 causes the recording paper P to be sent downwardly and fed to the conveying path 51.

As shown in FIG. 7, the conveying path 51 is formed such that it is laid downwardly from the position immediately under the lower end portion of the recording paper receiving unit 43, inverted in the vicinity of the bottom portion of the printer body 42, and after that, it is upwardly extended and communicated to the paper discharging port 44 formed on the top surface of the printer body 42. Thus, the recording paper P fed from the recording paper receiving unit 43 is conveyed downwardly through the conveying path 51 at the standing posture and then inverted so as to be U-turned. Then, it is again set at the standing posture and upwardly conveyed and then discharged from the paper discharging port 44. In this way, since the conveying path 51 is formed as the U-shaped path on the section in the thickness direction of the printer body 42, the recording paper P can be fed at the standing posture. As a result, the thickness of the printer body 42 can be made thinner, thereby miniaturizing the ink jet recording device 9 and reducing the floor area required to install the ink jet recording device 9. By the way, in this way, since the paper discharging port 44 is formed on the top surface of the printer body 42, the path of the conveying path 51 is U-shaped. However, the path of the conveying path 51 is not required to be limited to be U-shaped. For example, when the scanner unit 41 is not provided, since the paper discharging port can be formed on the front surface of the printer body 42, the path of the conveying path 51 can be formed in an L-shaped.

Also, as shown in FIG. 7, the ink jet recording head 52 is provided at the lowest portion of the path of the U-shaped conveying path 51, namely, the portion where the conveying path 51 is U-turned. This ink jet recording head 52 is arranged capable of scanning in the width direction (the y-axis direction in FIG. 5) of the conveying path 51 at the posture where the ink drop can be discharged downwardly from an under surface, in the inner side of the U-shaped curvature of the conveying path 51. On the other hand, the platen 53 is provided on the outer side of the conveying path 51 below the ink jet recording head 52.

While the foregoing ink jet recording head 52 discharges the respective inks of cyan (C), magenta (M), yellow (Y) and black (K) which are supplied through the pipings, such as the tubes and the like, from the ink cartridges 1 (refer to FIG. 3) attached inside the printer body 42, the scanning operation is executed, so that the image is recorded on the recording paper P conveyed through the conveying path 51, on the platen 53. By the way, although this is not shown in FIG. 7, the ink jet recording head 52 is mounted on a scanning carriage that is slidably provided on a guiding member extended in the width direction of the conveying path 51, inside the U-shaped curvature of the path of the conveying path 51. Then, since the scanning carriage is moved along the guiding member by a belt driving mechanism and the like, the ink jet recording head 52 is configured so as to be able to be scanned in the main scanning direction that is the width direction of the conveying path 51.

The platen 53 has the horizontal plane to support the recording paper P over the image recording range of the ink jet recording head 52, in order to horizontally support the recording paper P, which is conveyed through the conveying path 51, at the position where predetermined head gap is kept for the ink jet recording head 52. Also, although this is not shown in FIG. 7, a waste ink tray which receives and accumulates the inks discharged by the ink jet recording head 52 in order to protect the increase in the ink viscosity and remove the foreign materials and a purging mechanism which absorbs and removes the foreign materials and babble and the like from the ink jet recording head 52 are suitably provided in the portion in the side direction of the platen 53 that is outside the image recording range of the ink jet recording head 52.

Also, the conveying mechanism 56 where a plurality of pairs of a conveying rollers 59 and a pushing rollers 60 are suitably arranged are provided in the conveying path 51. The conveying roller 59 is rotationally driven by transmitting a driving force from a motor (not shown). On the other hand, the pushing roller 60 is rotatably provided in the state where it is pushed against the conveying roller 59 by a predetermined pushing force. Thus, when the recording paper P enters between the pushing roller 60 and the conveying roller 59, the pushing roller 60 is retracted by a length corresponding to the thickness of the recording paper P, and the recording paper P is sandwiched between it and the conveying roller 59. Thus, the rotation force of the conveying roller 59 is surely transmitted to the recording paper P. By the way, on the downstream side from the platen 53 of the conveying path 51, in the pushing roller 60 in the compressive contact with the recording side of the already-recorded recording paper P, the roller surface is spur-shaped such that the image recorded on the recording paper P is not deteriorated.

With the foregoing conveying mechanism 56, the recording paper P fed from the recording paper receiving unit 43 is conveyed through the conveying path 51 on the platen 53 and intermittently conveyed at a predetermined sub-scanning width on the platen 53. Then, each time it is conveyed for each scanning width, the ink jet recording head 52 is scanned in the main scanning direction. Consequently, the image is recorded from the front side of the recording paper P onto the rear side. In this way, the recording paper P where the image is recorded on a predetermined region is conveyed upwardly through the conveying path 51 at the standing posture, and the front portion is protruded from the paper discharging port 44.

The paper discharging stack 55 is provided in the most downstream side of the conveying path 51. The paper discharging stack 55 is formed as the space where the plurality of recording papers P can be kept at the standing posture, in order to store a part of the front side thereof in the state protruded from the paper discharging port 44. Thus, the recording papers P where the images are already recorded are sequentially stored in the paper discharging stack 55 in the state where the part of the front side thereof is protruded from the paper discharging port 44.

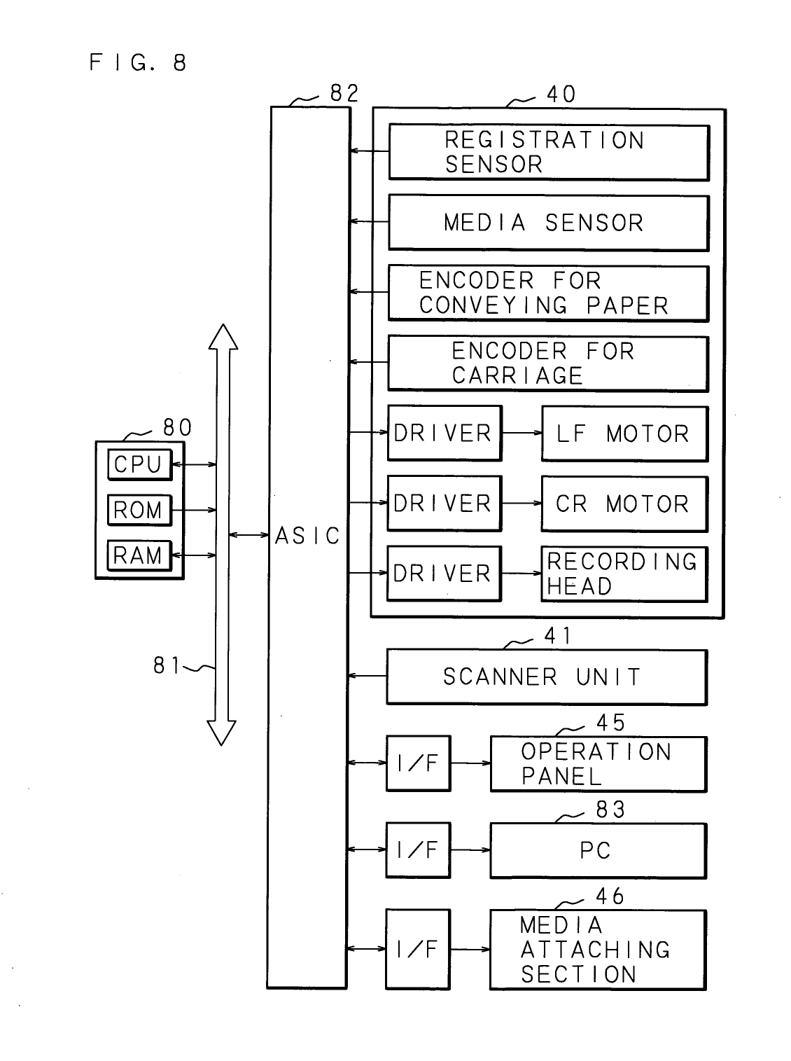

FIG. 8 is a block diagram showing the configuration of the controlling unit composed of the electronic parts 54 in the ink jet recording device 9. As shown in FIG. 8, the controlling unit has a processing unit 80 composed of CPU (Central Processing Unit), ROM (Read Only Memory) and RAM (Random Access Memory). Then, the processing unit 80 is connected through a bus 81 and an ASIC (Application Specific Integrated Circuit) 82 to the various sensors and motors of the printer unit 40 and the scanner unit 41, the operation panel 45, the media attaching portion 46 and the like so that data can be transmitted to and received from them. Also, the ink jet recording device 9 is connected to a computer (PC) 83. Accordingly, the ink jet recording device 9 can record the image and/or the document on the recording paper, in accordance with the image data and/or the document data transmitted from the computer 83, in addition to the input from the operation panel 45. For this reason, an interface (I/F) to transmit and receive the data to and from the computer 83 is provided.

The configuration of each cartridge attaching unit 48 will be described below by mainly referring to FIG. 9.

Each of the cartridge attaching units 48y, 48m, 48c and 48k to which the respective ink cartridges 1 are attached is configured as the space partitioned by a plurality of partition plates 61 so that each ink cartridge 1 can be received, inside the printer body 42 (refer to FIG. 7). One side surface of the space constituting each of the cartridge attaching units 48y, 48m, 48c and 48k is opened on the side surface of the printer body 42 (refer to FIG. 6). Hereafter, the side that is opened to the side surface of the printer body 42 of each of the cartridge attaching units 48y, 48m, 48c and 48k is referred to as an open side, and the side opposite to it is referred to as a depth side.

On the depth side of each space of the cartridge attaching units 48y, 48m, 48c and 48k, the hollow ink needle 62 and the guiding member 63 are provided corresponding to the ink supply port 5 and the guiding unit 7 of each ink cartridge 1. Each ink needle 62 is communicated to a sub ink tank 64 for each ink, which is provided inside the printer body 42 near each cartridge attaching unit 48y, 48m, 48c and 48k (refer to FIG. 7). Each sub ink tank 64 is provided for receiving each color ink supplied from each ink cartridge 1 and consequently capturing babbles, dusts and the like which are included in the ink. Between each sub ink tank 64 and the ink jet recording head 52 is connected through a flexible tube 65.

Since each of the cartridge attaching units 48y, 48m, 48c and 48k is similarly configured, hereafter, the cartridge attaching unit 48y is explained as an example. As shown in FIG. 10, the ink needle 62 is horizontally provided extending toward the open side of the cartridge attaching unit 48y from the portion near the lower end portion on the depth side surface of the same so that the tip protrudes into the space of the cartridge attaching unit 48y. On the other hand, the guiding member 63 is horizontally provided extending toward the open side of the cartridge attaching unit 48y from the portion near the upper end portion on the depth side surface of the same so that the tip protrudes into the space of the cartridge attaching unit 48y.

The guiding member 63 is a cylindrical member whose tip is closed, and a ventilation port 66 communicating to own hollow inner space is formed on the top surface of the tip portion. The base end side of the guiding member 63 is communicated to the inner space inside the printer body 42. Consequently, a series of paths is formed from the ventilation port 66 through the inner space of the guiding member 63 to the inner space of the printer body 42.

A hook portion 67 is formed on the upper end portion of the opening of the cartridge attaching unit 48y. The hook portion 67 is configured such that the partition plate 61 is horizontally protruded from the upper end portion of the opening of the cartridge attaching unit 48y to the outside to form a protrusion piece 68, and the front end portion of the protrusion piece 68 is formed in the shape of a fishing hook. The hook portion 67 is engaged with the upper end portion of the front surface of the ink cartridge 1 attached to the cartridge attaching unit 48y, and consequently positions and keeps the ink cartridge 1 at the attaching position of the cartridge attaching unit 48y. Also, a proper space 69 is formed in the portion above the hook portion 67 of the partition plate 61. When the protrusion piece 68 is bent to the space 69 side, the hook portion 67 can be elastically deformed to the upper portion.

FIG. 11 is a longitudinal sectional view showing the state where the ink cartridge 1 is attached to the cartridge attaching unit 48y. In this embodiment, the cartridge attaching unit 48y corresponds to the yellow ink. Accordingly, the ink cartridge 1 in which the yellow ink is filled is attached to the cartridge attaching unit 48y. When the ink cartridge 1 is inserted into the space of the cartridge attaching unit 48y, the cap 6 provided on the rear surface of the ink cartridge 1 is brought into contact with the ink needle 62. Moreover, when the ink cartridge 1 is pushed into the depth side of the cartridge attaching unit 48y, as shown in FIG. 11, the ink needle 62 penetrates the cap 6, and the tip thereof protrudes into the ink storage chamber 4. Consequently, through the ink needle 62, the ink cartridge 1, specifically, the ink storage chamber 4 and the sub ink tank 64 (refer to FIG. 4) are communicated.

Also, when the ink cartridge 1 is inserted into the space of the cartridge attaching unit 48y, the guiding member 63 is inserted into the guiding unit 7 provided on the rear surface of the ink cartridge 1. Consequently, the insertion of the ink cartridge 1 is guided by the guiding unit 7 and the guiding member 63. Then, when the ink cartridge 1 is further pushed into the depth side of the cartridge attaching unit 48y, the tip of the guiding member 63 is brought into contact with the sealing member 20. Thus, the sealing member 20 at the closed position is moved to the open position, in opposition to the elastically pushing force of the spring 21. Then, as shown in FIG. 11, when the ink cartridge 1 is completely attached to the cartridge attaching unit 48y, the sealing member 20 is further pushed by the guiding member 63 and moved to the open position. Thus, the ventilation port 18 made in the guiding member 63 is opened. Simultaneously, the tip of the guiding member 63 reaches the large diameter portion 17 of the guiding unit 7. Thus, the inner space of the guiding member 63 and the large diameter portion 17 formed in the portion of the depth side of the guiding unit 7 are communicated through the ventilation port 66. The large diameter portion 17 is communicated through the ventilation port 18 to the ink storage chamber 4. Hence, the ink storage chamber 4 is opened to the atmosphere through the path composed of the ventilation port 18, the ventilation port 66 and the guiding member 63. As mentioned above, the ink stored in the ink storage chamber 4 can flow out to the sub ink tank 64 through the ink needle 62.

Also, when the ink cartridge 1 is completely attached to the cartridge attaching unit 48y, the hook portion 67 is engaged with the vicinity of the hinge portion 10 at the upper end portion of the front surface of the ink cartridge 1. Thus, for example, even if the elastic deformation of the cap 6 into which the ink needle 62 is pierced generates the force for pushing back the ink cartridge 1, the hook portion 67 holds the ink cartridge 1 at the attaching position. In such attaching state of the ink cartridge 1, the handle 3 provided on the front surface of the cartridge body 2 is still in the state where it is laid down with respect to the front surface of the cartridge body 2. Consequently, since the handle 3 is positioned so as to be integrated with the front surface of the cartridge body 2, the protruding width of the handle 3 from the cartridge body 2 becomes small.

As mentioned above, the ink cartridge 1 in which the yellow ink is stored is attached to the corresponding cartridge attaching unit 48y. Also, similarly, the respective ink cartridges 1 which store the other magenta, cyan and black inks, respectively, are also attached to the corresponding other cartridge attaching units 48m, 48c and 48k, respectively. Then, the respective color inks flowing into the respective sub ink tanks 64 from the respective ink cartridges 1 are supplied through the respective tubes 65 to the ink jet recording head 52, as shown in FIG. 9.

The case of the detachment of the ink cartridge 1 will be described below. It is assumed that the respective ink cartridges 1 are respectively attached as shown in FIG. 11, in the respective cartridge attaching units 48y, 48m, 48c and 48k arranged vertically in the lines as shown in FIG. 6. Here, when the ink jet recording device 9 is the vertically installing type, it is expected to be placed and used not only on the desk but also on the floor. Thus, assuming that the front surface of each ink cartridge 1 is the flat vertical surface, even if the ink color stored in each ink cartridge 1 is displayed on the surface of each ink cartridge 1, unless the user bends its body so that the position of the eye is located in the side direction of each ink cartridge 1 or puts user's head deeply down, the user cannot judge whether which ink cartridge 1 corresponds to the ink color required to be exchanged.

In each ink cartridge 1, as shown in FIG. 3, the label 15 which represents the ink color stored in each ink cartridge 1 is stuck on the upward slant surface 14 formed on the side of the rotating tip portion 11 of the handle 3. This label 15 faces to the obliquely upward direction relative to the side surface of the printer body 42. Thus, even if the ink jet recording device 9 is installed on the floor, the user can visibly recognize the representation of the label 15 from the obliquely upward direction of the ink jet recording device 9 without bending user's body so that the position of user's eyes is located in the side direction of each ink cartridge 1. Thus, the user can find the ink cartridge 1 corresponding to the ink color desired to be exchanged by the user easily and quickly. Also, the representation of the label 15 can be visibly recognized even from the side direction of the ink jet recording device 9. Accordingly, for example, when the ink jet recording device 9 is placed on the desk, the user can find the ink cartridge 1 corresponding to the ink color to be exchanged, even from the side direction of the ink jet recording device 9 easily and quickly.

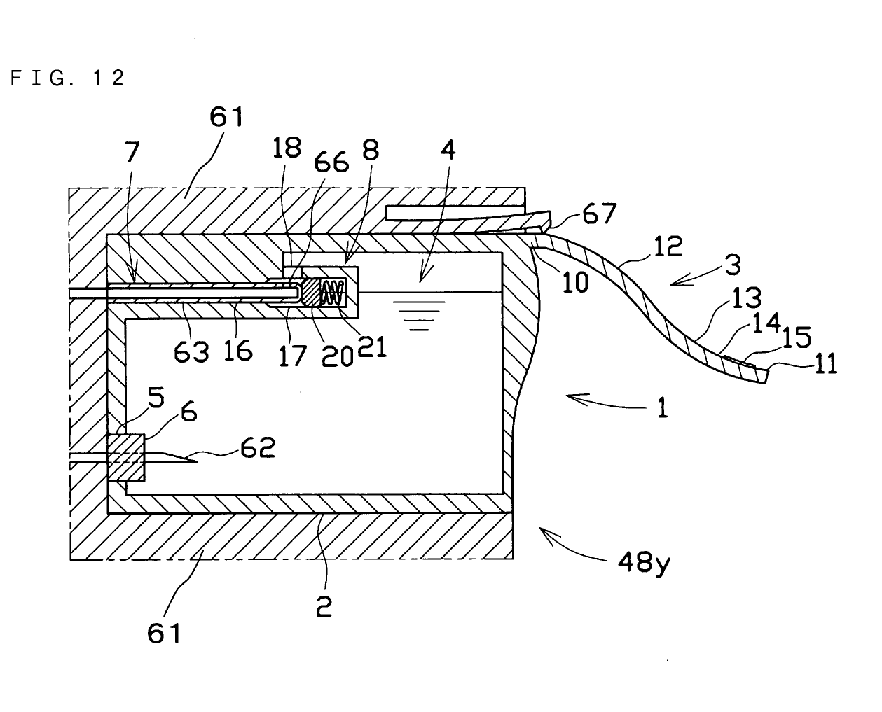

Then, as shown in FIG. 12, the user changes the posture of the handle 3 of the ink cartridge 1 to be exchanged, from the laid-down posture to the standing posture. Since the rotating tip portion 11 of the handle 3 is curved so as to rise with respect to the front surface of the cartridge body 2, gap exists between the cartridge body 2 and the rotating tip portion 11 of the handle 3. Accordingly, the user can easily put an index finger on the rotating tip portion 11 and pinch it between the index finger and the thumb, from the lower side of the handle 3 of the ink cartridge 1 in the state attached to the cartridge attaching unit 48y. The user makes the handle 3 become the standing posture by rotating upwardly and lifting up it. Consequently, the hook portion 67 engaged with the vicinity of the hinge portion 10 is pushed up by the upper end portion of the handle 3 and elastically deformed, which releases the fastened state by the hook portion 67 of the ink cartridge 1. In this way, since the posture change of the handle 3 and the release of the fastened state by the hook portion 67 are linked, the work for detaching the ink cartridge 1 is made easier. Also, since the user makes the handle 3 become the standing posture, the surface of the handle 3 faces upwardly. Hence, when the ink cartridge 1 is pulled out from above, the position of the ink cartridge 1 is easily checked, and the pulling out work becomes easy.

The user, after making the handle 3 become the standing posture, grips the handle 3 and pulls the ink cartridge 1 to the side direction of the ink jet recording device 9. In the handle 3, as mentioned above, the valley portion 13 is formed on the portion on the rotating tip portion 11 side out of the center portion. The curvature state of this valley portion 13 fits the swelling of the belly of the thumb that pinches the rotating tip portion 11 side of the handle 3 of the user. Thus, the operational feeling is improved.

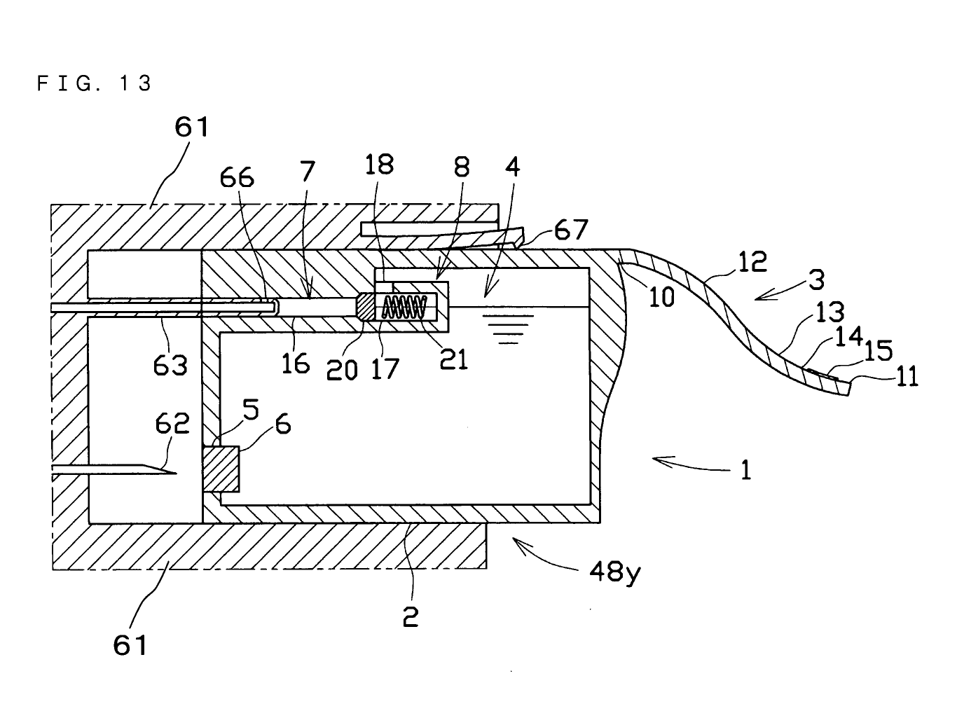

As shown in FIG. 13, the ink cartridge 1 is guided by the guiding unit 7 and the guiding member 63 and pulled to the side direction of the ink jet recording device 9. Consequently, for example, when the ink cartridge 1 is pulled from the obliquely upward direction of the cartridge attaching unit 48y, the ink cartridge 1 is guided to the side direction without being pulled to the obliquely upward direction. Thus, the user can easily pull the ink cartridge 1. Also, the hinge portion 10 where the pulling force is transmitted from the handle 3 to the cartridge body 2 is located near the extending direction of the guiding unit 7. Thus, the force from the handle 3 acts on the pull direction guided by the guiding unit 7 and the guiding member 63. Hence, since the force biased against the pull direction does not act on the cartridge body 2, the ink cartridge 1 is smoothly pulled without any unsteadiness.

In association with the fact that the ink cartridge 1 is pulled from the cartridge attaching unit 48y, the ink needle 62 is pulled out from the cap 6. With the elastic force, the cap 6 seals the pierced trace by the ink needle 62. Thus, after the ink needle 62 is pulled out, the ink of the ink storage chamber 4 is never leaked. Also, the guiding member 63 is simultaneously pulled out from the guiding unit 7. Consequently, the sealing member 20, which is forced to be located at the open position because it is pushed by the guiding member 63, is moved to the closed position by the elastically pushing force of the spring 21. As a result, the ink storage chamber 4 is closed for the atmosphere. Then, the user, after completely pulling out the ink cartridge 1 from the cartridge attaching unit 48y, attaches a new ink cartridge 1 to the cartridge attaching unit 48y similarly to the foregoing case.

In this way, according to the above-mentioned ink cartridge 1, when the handle 3 is made to become the laid-down posture, the protruding width of the handle 3 from the front surface of the cartridge body 2 becomes small, which reduces the space required to attach the ink cartridge 1. Thus, the ink jet recording device 9 can be miniaturized. Inversely, when the handle 3 is made to become the standing posture, the user easily grips the handle 3 and pulls out the ink cartridge 1. Hence, both of the miniaturization of the ink jet recording device 9 and the improvement of the workability when the ink cartridge 1 is exchanged can be realized at the same time.

### Second Embodiment

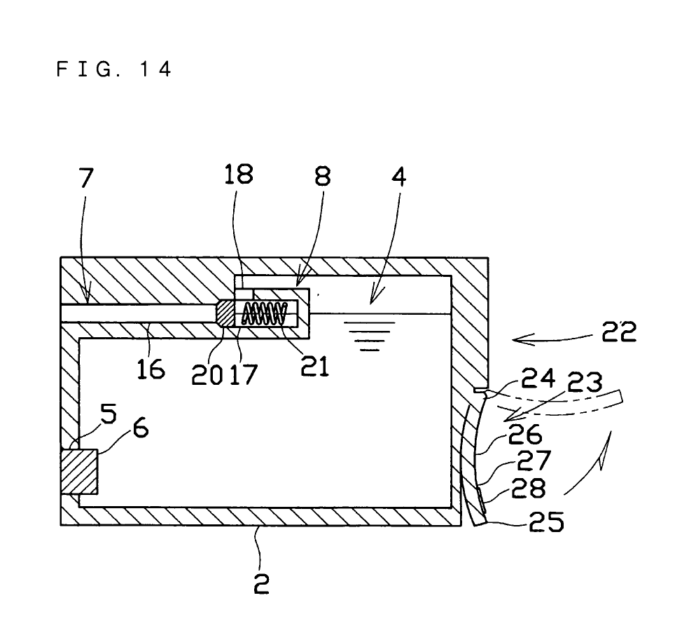

The second embodiment of the present invention will be described below with reference to FIG. 14 that is the longitudinal sectional view showing the inner configuration of the ink cartridge according to the second embodiment of the present invention.

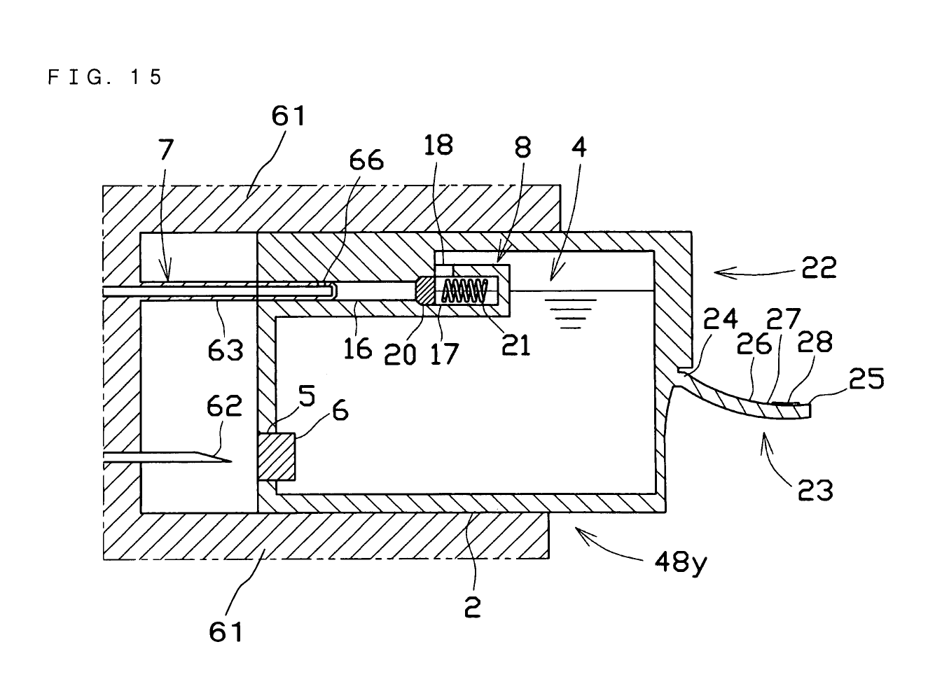

An ink cartridge 22 according to the second embodiment has the configuration similar to the ink cartridge 1 according to the first embodiment, except that the mounting position of a handle 23 denoted by reference numeral 3 in the first embodiment is different. Thus, only the different portions are explained, and the explanations of the similar configurations are omitted. Also, in FIG. 14 and FIG. 15 which will be described later, the same reference numeral as the first embodiment denotes the same component.

The fact that the handle 23 is rotatably provided on the front surface of the cartridge body 2, namely, on a side exposed to the outer side surface of the ink jet recording device 9 when the ink cartridge 22 is attached to the side surface of the ink jet recording device 9 is similar to the first embodiment. However, in the second embodiment, the handle 23 is molded integrally with the cartridge body 2 where the substantial center portion on the front surface of the cartridge body 2 is made to be a hinge portion 24. Thus, the handle 23 can take the two postures, that is, a standing posture (indicated by an alternate long and two short dashes line) in which the handle 23 stands up with respect to the front surface of the cartridge body 2 and a laid-down posture (indicated by a solid line) in which the handle 23 is laid down with respect to the front surface of the cartridge body 2, where the hinge portion 24 at the center portion of the handle 23 is made to be a rotating axis, as shown in FIG. 14. Also in this second embodiment, it is naturally possible to change to the other known rotating means, such as the use of the rotation shaft or the like, instead of the hinge portion 24.

Also, the handle 23 is a corrugated plate having a curvature. In the laid-down posture indicated by the solid line in FIG. 14, namely, in the state where the handle 23 is laid down with respect to the front surface of the cartridge body 2, a rotating tip portion 25 is curved so as to rise and separate with respect to the front surface of the cartridge body 2. Further, on the center portion in the vertical direction of the handle 23, a valley portion 26 recessed toward the front surface of the cartridge body 2 is formed. Since the rotating tip portion 25 and the valley portion 26 are formed continuously as the gentle curvature, the handle 23 has the corrugated shape where the upper end portion and lower end portion wind up and down with respect to the front surface of the cartridge body 2.

The portion from the valley portion 26 to the rotating tip portion 25 of the handle 23 becomes an upward slant surface 27 where the surface of the handle 23 faces to the obliquely upward direction. A label 28 is stuck on this upward slant surface 27. In the label 28, the ink color stored in the ink cartridge 22 is represented. The representation of the ink color may be the indication such as the character and/or symbol, mark and the like, which can be visibly recognized by the user, similarly to the first embodiment. Also, the method of representing the ink color is not especially limited. It is naturally possible to employ the other known techniques, for example, such as the direct printing on the surface of the handle 23, instead of the label 28.

Since the state where the ink cartridge 22 is attached to the cartridge attaching unit 48y is similar to the first embodiment, the detailed explanation using the drawings is omitted. Since the ink cartridge 22 is attached to the cartridge attaching unit 48y, the ink needle 62 penetrates the cap 6, and the ink storage chamber 4 of the ink cartridge 22 is communicated to the sub ink tank 64. Also, the guiding member 63 is inserted into the guiding unit 7, and the sealing member 20 is pushed against the guiding member 63 and moved to the open position. Thus, the ink storage chamber 4 is opened to the atmosphere. In the attaching state of the ink cartridge 22 to the cartridge attaching unit 48y as mentioned above, the handle 23 provided on the front surface of the cartridge body 2 becomes in the state where the handle 23 is laid down with respect to the front surface of the cartridge body 2. Consequently, since the handle 23 is positioned so as to be integrated with the front surface of the cartridge body 2, the protruding width of the handle 3 from the cartridge body 2 becomes small.

When the ink cartridge 22 is detached, the user firstly selects the ink cartridge 22 of the ink color that is desired to be exchanged, from the respective ink cartridges 22 attached to the respective cartridge attaching units 48y, 48m, 48c and 48k arranged vertically in the lines. As mentioned above, on the handle 23 of each ink cartridge 22, the label 28 representing the ink color stored in each ink cartridge 22 is stuck on the upward slant surface 27 formed on the rotating tip portion 25 side. The label 28 faces to the obliquely upward direction from the side surface of the printer body 42. Thus, even if the ink jet recording device 9 is installed on the floor, the user can visibly recognize the representation of the label 28 from the obliquely upward direction of the ink jet recording device 9, without squatting down so that the position of the user's eyes is located in the side direction of each ink cartridge 22. Hence, the user can find the ink cartridge 22 corresponding to the ink color desired to be exchanged easily and quickly. Also, the representation of the label 28 can be visibly recognized even from the side direction. Hence, for example, when the ink jet recording device 9 is installed on the desk, the user can find the ink cartridge 22 corresponding to the ink color to be exchanged even from the side direction easily and quickly.

Then, as shown in FIG. 15, the user changes the posture of the handle 23 of the ink cartridge 22 to be exchanged, from the laid-down posture to the standing posture. Since the rotating tip portion 25 of the handle 23 is curved so as to rise with respect to the surface of the cartridge body 2, gap exists between it and the cartridge body 2. Thus, the user can easily put, for example, the tip of the index finger on the rotating tip portion 25 and pinch it between the index finger and the thumb, from below the handle 23 for the ink cartridge 22 in the attaching state. Then, the user makes the handle 23 to become the standing posture by rotating upwardly and lifting up it. Since the user makes the handle 23 become the standing posture, the surface of the handle 23 faces upwardly. Hence, when the ink cartridge 22 is pulled out from above, the user can easily recognize the position of the ink cartridge 22, and the pulling out work becomes easy. By the way, although this is not shown in FIG. 14, when the hook portion 67 of the cartridge attaching unit 48y is provided at the position corresponding to the hinge portion 24 of the handle 23, similarly to the first embodiment, by making the handle 23 become the standing posture, it is possible to automatically release the fastened state by the hook portion 67.

The user, after making the handle 23 become the standing posture, grips the handle 23 and pulls the ink cartridge 22 to the side direction. The valley portion 26 is formed on the handle 23. The curvature state of this valley portion 26 fits the swelling of the belly of the thumb that pinches the handle 23 of the user. Thus, the operational feeling is improved.

As shown in FIG. 15, the ink cartridge 22 is guided by the guiding unit 7 and the guiding member 63 and pulled to the side direction of the ink jet recording device 9. In association with the fact that the ink cartridge 22 is pulled from the cartridge attaching unit 48y, the ink needle 62 is pulled out from the cap 6. At this time, the cartridge body 2 involves a sliding friction between the guiding unit 7 and the guiding member 63 and a sliding friction between the ink needle 62 and the cap 6. However, the hinge portion 24 where the pulling force is transmitted from the handle 23 to the cartridge body 2 is located at the substantial center portion on the front surface of the cartridge body 2. Thus, the force biased against the pull direction does not act on the cartridge body 2. Consequently, the ink cartridge 22 is smoothly pulled from the cartridge attaching unit 48y without any unsteadiness.

When the ink cartridge 22 is completely pulled out from the cartridge attaching unit 48y, the ink needle 62 is pulled out from the cap 6, and the sealing member 20, which is pushed by the guiding member 63 and forced to be located at the open position, is moved to the closed position by the elastically pushing force of the spring 21. Then, the user, after completely pulling out the ink cartridge 22 from the cartridge attaching unit 48y, attaches the new ink cartridge 22 in the cartridge attaching unit 48y similarly to the above-mentioned case.

In this way, according to the ink cartridge 22 in the second embodiment, when the handle 23 is made to become the laid-down posture, the width where the handle 23 protrudes from the front surface of the cartridge body 2 becomes small, which reduces the space required to attach the ink cartridge 22. Thus, the ink jet recording device 9 can be miniaturized. Inversely, when the handle 23 is made to become the standing posture, the user easily grips the handle 23 and pulls out the ink cartridge 22. Hence, both of the miniaturization of the ink jet recording device 9 and the improvement of the workability when the ink cartridge 22 is exchanged can be realized at the same time.

### Third Embodiment

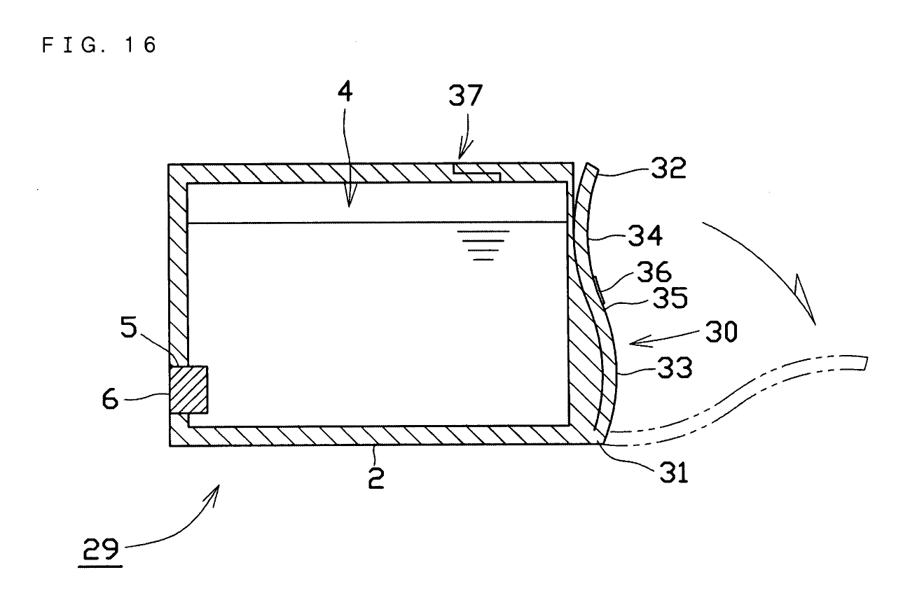

The third embodiment of the present invention will be described below with reference to FIG. 16 of a longitudinal sectional view showing the inner configuration of the ink cartridge according to the third embodiment of the present invention.

In an ink cartridge 29 according to the third embodiment, the mounting position of a handle 30 denoted by reference numeral 3 in the first embodiment differs from the ink cartridge 1 in the first embodiment. Also, the guiding unit 7 provided on the upper end portion of the rear surface of the cartridge body 2 in the first embodiment is not provided in this third embodiment. In addition, the component to which the same reference numeral as the ink cartridge 1 according to the first embodiment is given denotes the same component. Thus, the explanation of it is omitted.

The handle 30 is rotatably provided on the front surface of the cartridge body 2, namely, on the side exposed to the outer side surface, when the ink cartridge 29 is attached to the side surface of the ink jet recording device 9. The handle 30 is formed integrally with the cartridge body 2 where the lower end portion of the front surface of the cartridge body 2 is made to be a hinge portion 31. Thus, the handle 30 can take two postures, that is, a standing posture (indicated by a alternate long and two short dashes line) where the handle 30 stands up with respect to the front surface of the cartridge body 2 and a laid-down posture (indicated by a solid line) where the handle 30 is laid down with respect to the same, where the hinge portion 31 at the lower end portion on the front surface of the cartridge body 2 is made to be a rotating axis, as shown in FIG. 16. By the way, also in this third embodiment, it is naturally possible to change to the other known rotating means, such as the use of the rotation shaft or the like, instead of the hinge portion 31.

The handle 30 of the third embodiment is a corrugated plate having a curvature. In the laid-down posture indicated in FIG. 16, namely, in the state where the handle 23 is laid down with respect to the front surface of the cartridge body 2, a rotating tip portion 32 is curved so as to rise and separate with respect to the front surface of the cartridge body 2. Moreover, in the portion of the rotating axis side out of the center portion in the vertical direction of the handle 30, a top portion 33 rising with respect to the front surface of the cartridge body 2 is formed. Also, in the portion on the side of the rotating tip portion 32 out of the center portion in the vertical direction of the handle 30, a valley portion 34 recessed toward the front surface of the cartridge body 2 is formed. Since the foregoing rotating tip portion 32, top portion 33 and valley portion 34 are formed continuously as the gentle curvature, the handle 30 has the corrugated shape where it winds up and down along the vertical direction.

As mentioned above, the valley portion 34 recessed toward the surface of the cartridge body 2 is formed from the center portion of the handle 30 towards the rotating tip portion 32 side, and the surface of the handle 30 rises from this valley portion 34 towards the center portion of the handle 30. Accordingly, from the valley portion 34 of the handle 30 towards the center portion of the handle 30, there is an upward slant surface 35 where the surface of the handle 30 faces to the obliquely upward direction. A label 36 is stuck on this upward slant surface 35. On this label 36, the ink color stored in the ink cartridge 29 is represented. By the way, similarly to the above mentioned first embodiment, the representation of the ink color may be the indication such as the character and/or symbol, mark and the like, which can be visibly recognized by the user. Also, the method of representing the ink color is not especially limited. It is naturally possible to employ the other known techniques, for example, such as the direct printing on the surface of the handle 23 and the like.

As shown in FIG. 16, the ink storage chamber 4 for storing the ink is formed inside the cartridge body 2. Also, an atmosphere communicating path 37 for opening the ink storage chamber 4 to the atmosphere is formed on the top surface of the cartridge body 2. The atmosphere communicating path 37 is embodied known atmosphere opening means having a labyrinth shape or the like formed in the cartridge body 2.

Also, the ink supply port 5, which is communicated to the ink storage chamber 4 from the rear surface of the cartridge body 2, is bored in the vicinity of the lower end portion on the rear surface of the cartridge body 2. The ink supply port 5 is sealed by the cap 6. The hinge portion 31 serving as the rotating axis of the handle 30 is provided on the lower end portion on the front surface of the cartridge body 2 near a production in the protruding direction of the ink needle 62 which is pierced through the cap 6.

The state where the ink cartridge 29 of the third embodiment as mentioned above is attached to the cartridge attaching unit 48y is similar to the first embodiment. Thus, the detailed explanation using the drawings is omitted. When the ink cartridge 29 is attached to the cartridge attaching unit 48y, the ink needle 62 penetrates the cap 6, and the sub ink tank 64 (refer to FIG. 9) is communicated to the ink cartridge 29. By the way, the ink storage chamber 4 is opened through the atmosphere communicating path 37 to the atmosphere.

Also, in the third embodiment, a hook portion 67 is formed on the lower end portion of the opening of the cartridge attaching unit 48y. Thus, when the ink cartridge 29 is completely attached to the cartridge attaching unit 48y, the hook portion 67 is engaged with the vicinity of the hinge portion 31 on the lower end portion of the ink cartridge 29. In the attaching state of the ink cartridge 29 to the cartridge attaching unit 48y as mentioned above, the handle 30 provided on the front surface of the cartridge body 2 is made to become the state where the handle 30 is laid down with respect to the front surface of the cartridge body 2. Consequently, since the handle 30 is positioned so as to be integrated with the front surface of the cartridge body 2, the protruding width of the handle 30 from the cartridge body 2 becomes small.

When the ink cartridge 1 is detached, the user firstly selects the ink cartridge 29 of the ink color that is desired to be exchanged, from the respective ink cartridges 29 attached to the respective cartridge attaching units 48y, 48m, 48c and 48k arranged vertically in the lines. As mentioned above, on the handle 30 of each ink cartridge 29, the label 36 representing the ink color stored in each ink cartridge 29 is stuck on the upward slant surface 35 formed on the rotating tip portion 32 side of the handle 30. Since the label 36 faces to the obliquely upward direction from the side of the printer body 42, even if the ink jet recording device 9 is installed on the floor, the user can visibly recognize the representation of the label 36 from the obliquely upward direction of the ink jet recording device 9, without squatting down so that the position of the user's eyes is located in the side direction of each ink cartridge 29. Hence, the user can find the ink cartridge 29 corresponding to the ink color desired to be exchanged easily and quickly. Also, the representation of the label 36 can be visibly recognized even from the side direction. Hence, for example, when the ink jet recording device 9 is placed on the desk, the user can find the ink cartridge 29 corresponding to the ink color to be exchanged even from the side direction easily and quickly.

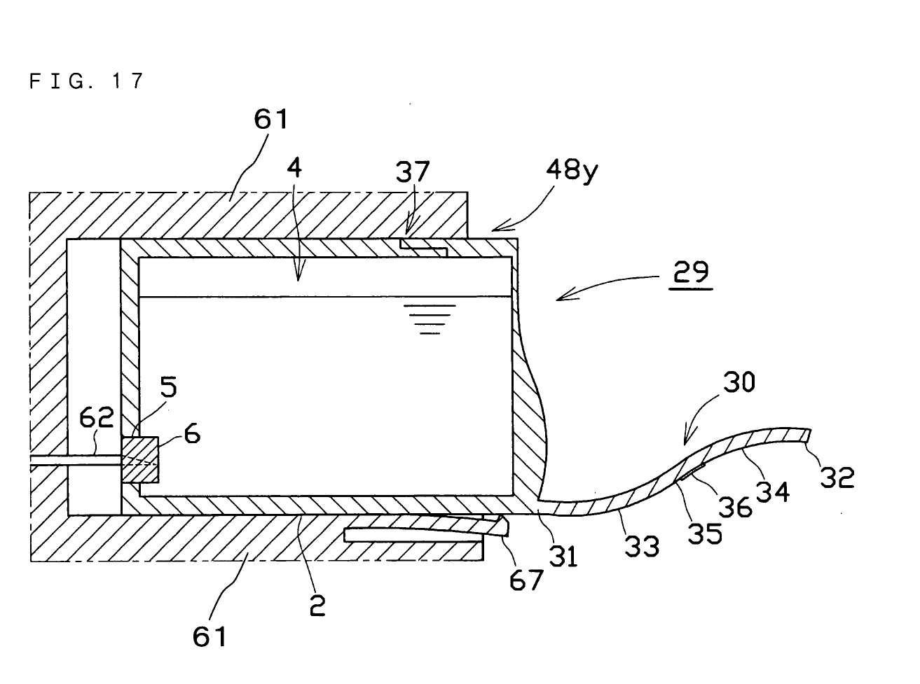

Then, as shown in FIG. 17, the user changes the posture of the handle 30 of the ink cartridge 29 to be exchanged, from the laid-down posture to the standing posture. Since the rotating tip portion 32 of the handle 30 is curved so as to rise to the side direction of the ink jet recording device 9 from the front surface of the cartridge body 2, gap exists between it and the cartridge body 2. Thus, the user can easily put, for example, the tip of the index finger on the rotating tip portion 32 and pinch it between the index finger and the thumb, from above the handle 30 for the ink cartridge 29 in the attaching state. Then, the user makes the handle 30 become the standing posture by rotating downwardly and pulling down it. Consequently, the hook portion 67 engaged with the vicinity of the hinge portion 31 is pushed down to the handle 30, and elastically deformed, which releases the fastened state by the hook portion 67 in the ink cartridge 29. In this way, the posture change of the handle 30 and the release of the fastened state by the hook portion 67 are linked, which makes the operation for detaching the ink cartridge 29 easier.

The user, after making the handle 30 become the standing posture, grips the handle 30 and pulls the ink cartridge 29 to the side direction of the ink jet recording device 9. The valley portion 34 is formed on the handle 30. The curvature state of this valley portion 34 fits the swelling of the belly of the thumb that pinches the handle 30. Thus, the operational feeling is improved.

As shown in FIG. 17, in association with the fact that the ink cartridge 29 is pulled from the cartridge attaching unit 48y, the ink needle 62 is pulled out from the cap 6. At this time, in the cartridge body 2, a sliding friction is generated between the ink needle 62 and the cap 6. However, since the hinge portion 31 where the pulling force is transmitted from the handle 30 to the cartridge body 2 is located near the production in the protrusion direction of the ink needle 62, the force biased against the sliding friction does not act on the cartridge body 2, and the ink cartridge 29 is smoothly pulled from the cartridge attaching unit 48y without any unsteadiness.

When the ink cartridge 29 is completely pulled out from the cartridge attaching unit 48y, the ink needle 62 is pulled out from the cap 6. Then, the user, after completely pulling out the ink cartridge 29 from the cartridge attaching unit 48y, attaches the new ink cartridge 29 in the cartridge attaching unit 48y similarly to the above-mentioned case.

As mentioned above, according to the ink cartridge 29 in the third embodiment, when the handle 30 is made to become the laid-down posture, the width when the handle 30 protrudes from the front surface of the cartridge body 2 becomes small, which reduces the space required to attach the ink cartridge 29. Thus, the ink jet recording device 9 can be miniaturized. Inversely, when the handle 30 is made to become the standing posture, the user easily grips the handle 30 and pulls out the ink cartridge 29. Hence, both of the miniaturization of the ink jet recording device 9 and the improvement of the workability when the ink cartridge 29 is exchanged can be realized at the same time.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds there-of are therefore intended to be embraced by the claims.

1. An ink cartridge for an ink jet recording device, comprising:
a hollow cartridge body which can be attached to and detached from a cartridge attaching unit formed in said ink jet recording device;
an ink storage chamber which is formed inside said hollow cartridge body, and stores an ink;
an ink supply port which can open in order to supply the ink from said ink storage chamber to an outside of said cartridge body, and is sealed by an ink sealing member; and
a plate-shaped handle which is rotatably provided on a front surface of said cartridge body, and can take two postures of a standing posture to be stood up with respect to said front surface of said cartridge body, and a laid-down posture to be laid down with respect to the same;
wherein said handle is exposed to outside when said cartridge body is attached to said cartridge attaching unit.

2. The ink cartridge as set forth in claim 1, wherein
said ink jet recording device is a vertically installing type whose shape is a flat rectangular parallelepiped, and is installed under a state where its vertical dimension is larger than its first horizontal dimension and/or its second horizontal dimension perpendicular to said first horizontal dimension, and
said cartridge body is to be attached to said ink jet recording device, under a state where a longitudinal direction of said front surface thereof is made to be vertical.

3. The ink cartridge as set forth in claim 2, wherein
said cartridge attaching unit is formed in a side surface of said ink jet recording device, and
said cartridge body is to be attached to and detached from said cartridge attaching unit, by being inserted into and pulled out from the side surface of said ink jet recording device.

4. The ink cartridge as set forth in claim 3, wherein said handle is curved such that, in the case of said laid-down posture with respect to said cartridge body, a rotating tip side rises and separates from the front surface of said cartridge body.

5. The ink cartridge as set forth in claim 4, wherein said handle is formed in a corrugation-shaped so as to rise with respect to the front surface of the cartridge body and to be recessed toward the front surface along a vertical direction, in the case of said laid-down posture with respect to the front surface of said cartridge body.

6. The ink cartridge as set forth in claim 5, wherein
said handle has an upward slant surface facing, in said laid-down posture, to an obliquely upward direction, and
said upward slant surface has a representation for representing an ink color stored in said ink storage chamber.

7. The ink cartridge as set forth in claim 6, wherein
said cartridge body has a guiding unit extended in an attaching/detaching direction in order to guide a moving direction at a time of the attaching/detaching by engaging with said cartridge attaching unit, and
a rotating axis of said handle is provided near an intersection with a production in the extending direction of said guiding unit, on said front surface of said cartridge body.

8. The ink cartridge as set forth in claim 7, wherein an atmosphere communicating path for opening said ink storage chamber to atmosphere when said cartridge body is attached to said cartridge attaching unit is provided in said guiding unit.

9. The ink cartridge as set forth in claim 8, further comprising an air sealing member capable of taking two positions of an open position where said atmosphere communicating path is opened and a closed position where said atmosphere communicating path is closed, in accordance with the detachment or attachment of said cartridge body from or to said cartridge attaching unit formed in said ink jet recording device.

10. The ink cartridge as set forth in claim 9, wherein said handle is formed integrally with said cartridge body.

11. The ink cartridge as set forth in claim 6, wherein a rotating axis of said handle is provided at a center portion in the vertical direction on said front surface of said cartridge body.

12. The ink cartridge as set forth in claim 11, wherein
said cartridge body is engaged with a hook portion provided in said cartridge attaching unit, when being attached to said cartridge attaching unit formed in said ink jet recording device, and
said engagement with said hook portion is released, when a posture of said handle is changed from said laid-down posture to said standing posture.

13. The ink cartridge as set forth in claim 12, wherein said handle is formed integrally with said cartridge body.

14. The ink cartridge as set forth in claim 6, wherein
said ink supply port opens said ink storage chamber, when a hollow needle provided protruding in said cartridge attaching unit is pierced through said ink sealing member, and
a rotating axis of said handle is provided near an intersection with a production in an extending direction of said hollow needle, on said front surface of said cartridge body.

15. The ink cartridge as set forth in claim 14, wherein
said cartridge body is engaged with a hook portion provided in said cartridge attaching unit, when being attached to said cartridge attaching unit formed in said ink jet recording device, and
said engagement with said hook portion is released, when a posture of said handle is changed from said laid-down posture to said standing posture.

16. The ink cartridge as set forth in claim 15, wherein said handle is formed integrally with said cartridge body.
